(19) United States
(12) Patent Application Publication
(10) Pub. No.: US 2004/0137878 A1
(43) Pub. Date: Jul. 15, 2004

(54) AV data wireless communication system, communication apparatus, and electronic device

(76) Inventor: Kazuya Oyama, Ikoma-Shi (JP)

Correspondence Address: BIRCH STEWART KOLASCH & BIRCH, PO BOX 747, FALLS CHURCH, VA, 22040-0747, US

(21) Appl. No.: 10/743,761

(22) Filed: Dec. 24, 2003

(30) Foreign Application Priority Data
Dec. 27, 2002 (JP) 2002-382449

(51) Int. Cl. H04M 1/66; H04M 1/68; H04M 3/16

(52) U.S. Cl. 455/411; 455/410

(57) ABSTRACT

When it is desired that an AV data receiver receives an AV data signal from an AV data transmitter, a remote controller requests the AV data transmitter to transmit an ID code. The AV data transmitter generates an encrypted ID code and a decryption code on the basis of the ID code. The AV data receiver receives the encrypted ID code over infrared communication through the remote controller, receives the decryption code over wireless communication, decrypts the encrypted ID code using the decryption code, and thereby obtains the ID code.

### BACKGROUND OF THE INVENTION

1. Field of the Invention

The present invention relates to an AV data transmitter which encrypts AV data with an encryption code and which transmits the encrypted AV data over wireless communication, an AV data receiver which receives encrypted AV data over wireless communication and which decodes the encrypted AV data, and an AV data wireless communication system which includes the AV data transmitter and the AV data receiver.

2. Description of the Related Art

In recent years, an AV data wireless communication system in which AV data is transmitted to an AV reproduction apparatus such as a display or a projector from an AV source device such as a tuner, a video or a DVD and in which AV data is displayed or outputted in the form of a picture or a voice on or from the AV reproduction apparatus has been proposed following an increase in the complexity of wired connection and the development of wireless technology. To realize this AV data wireless communication system, an AV data transmitter which transmits the AV data provided from the AV source device and an AV receiver is connected to the AV reproduction apparatus. Alternatively, this AV data transmitter is included in the AV source device and the AV data receiver is included in the AV reproduction apparatus, whereby the AV data wireless communication system is constituted by the AV source device and the AV reproduction apparatus.

In the AV data wireless communication system of this type, because of a copyright of the AV data, the AV data transmitter and the AV data receiver are provided in a one-to-one correspondence so that the AV data cannot be transmitted and received between an AV data transmitter and an AV data receiver that constitute another wireless communication system. FIG. 38 illustrates a configuration in that a plurality of conventional AV data wireless communication systems are employed.

In FIG. 38, two AV data wireless communication systems are provided. Among them, in one AV data wireless communications system X, AV data outputted from an AV source device 1 is transmitted from an antenna 511 of an AV data transmitter 101 connected to the AV source device 1 by a cable. This AV data from the AV source device 1 is received by an AV data receiver 102 through an antenna 541, supplied to an AV reproduction apparatus 2 connected to the AV data receiver 102 by a cable, and reproduced and displayed by the AV reproduction apparatus 2.

Further, when a remote controller 11 for operating the AV source device 1 is operated to transmit an infrared signal, the infrared signal is received by an infrared signal reception unit 553 in the AV data receiver 102, converted into a wireless communication signal, and transmitted from the antenna 541. When the AV data transmitter 101 receives this signal through the antenna 511, the AV data transmitter 101 converts the received signal into an infrared signal and transmits the infrared signal from an infrared signal transmission unit 517, an infrared signal reception unit 12 in the AV source device 1 receives the infrared signal, and the AV source device 1 performs an operation indicated by the remote controller 11.

Further, in the other AV data wireless communication system Y, when AV data is transmitted from an antenna 511 of an AV data transmitter 103 which has a function of an AV source device, an AV data receiver 104 which has a function of an AV reproduction apparatus receives the AV data through an antenna 541, projects the AV data, and reproduces and displays the projected AV data on a screen 13. When a remote controller 14 is operated to operate the AV data transmitter 103, an infrared signal reception unit 553 of the AV data receiver 104 receives an infrared signal, converts the infrared signal into a wireless communication signal, and transmits the wireless communication signal from the antenna 541. When the AV data receiver 103 receives this signal through the antenna 511, the AV data receiver 103 performs an operation indicated by the remote controller 14.

As shown in FIG. 39, the AV data transmitter 101 includes an analog input unit 502 which inputs analog AV data such as NTSC data and a digital input unit 501 which inputs a digital signal. The analog data is digitized by an A/D converter unit (hereinafter, referred to as “A/D”) 503 and encoded by an MPEG unit 504. Various types of data is put in order by a data generation unit 505, and an error correction code is added to the data by an error correction code addition unit 506. The data is encrypted (scrambled) by a data scramble unit 507, and transmitted toward the AV data receiver by way of a baseband (hereinafter, referred to as “BB”) 509, a radio frequency amplification circuit (hereinafter, referred to as “RF”) 510 and the antenna 511. An ID used when the data scramble unit 507 scrambles the data is stored in an ID storage unit 520. In the case where data to be inputted is digital data, the data is supplied from the digital input unit 501 directly to the data generation unit 505.

FIG. 40 illustrates the configuration of the AV data receiver 102, wherein the data is received through the antenna 541, an RF 542 and a BB 543, descrambled by a descramble unit 544, subjected to AV data sorting, shortage determination and the like by a data analysis unit 545, decoded by an MPEG unit 546, converted into an analog signal by a D/A conversion unit (hereinafter, referred to as “D/A”) 547, and outputted as data such as NTSC data from an analog output unit 548. An ID used when the descramble unit 544 descrambles the data is stored in an ID storage unit 560. In the case where digital data is to be outputted, the data from the data analysis unit 545 is outputted through a digital output analysis unit 549 and a digital output unit 550.

Further, in the AV data receiver 102, the data analysis unit 545 determines whether a data packet is correctly received. When the data analysis unit 545 determines that the data packet is not correctly received, a retransmission request packet generation unit 558 generates a retransmission request packet for the packet which is not received. The AV data receiver 102 further includes an operation unit 551 which inputs a signal for controlling the AV source device 1 and the infrared signal reception unit 553 which receives the infrared signal from the remote controller 11. The data from the operation unit 551 is converted by an operation unit data conversion unit 552, and a signal received by the infrared signal reception unit 553 is converted by a remote control data conversion unit 554. A data generation unit 555 generates transmission data using a packet of the converted data and the retransmission request packet from the retransmission request packet generation unit 558. An error correction code addition unit 556 adds the error correction code to the transmission data thus generated. The resultant data is scrambled by a data scramble unit 557 and then transmitted to the AV data transmitter 101 through the BB 543, the RF 542 and the antenna 541.

When the AV data transmitter 101 receives the data through the antenna 511, the RF 510 and the BB 509, a descramble unit 512 descrambles the data, a data analysis unit 513 determines whether the AV data receiver 102 correctly receives a packet and put the data in order. In the case where a retransmission request is recognized, a retransmission request packet generation unit 514 generates a data packet of the AV data for which the retransmission request is issued. Further, the data which is obtained by the data analysis unit 513 and which operates the AV source device 1 is converted into a remote control signal by a remote control data analysis unit 516, and transmitted as the infrared signal from the infrared signal transmission unit 517. Digital data other than the remote control signal is outputted from a digital data output unit 519 through a digital data analysis unit 518.

The AV data transmitter 103 has functions of the AV source device 1 in place of the digital input unit 501, the analog input unit 502, the infrared signal transmission unit 517 and the digital data output unit 519. In addition, the AV data receiver 104 has functions of the AV reproduction apparatus 2 in place of the analog output unit 548 and the digital output unit 550.

In FIG. 38, an ID code recorded on the AV data transmitter 101 and the AV data receiver 102 that constitute the wireless communication system X is fixed to an ID code A. On the other hand, an ID code recorded on the AV data transmitter 103 and the AV data receiver 104 that constitute the wireless communication system Y is fixed to an ID code B. Therefore, the AV data can be transmitted between the AV data transmitter 101 and the AV receiver 102 equal in ID code over wireless communication. Likewise, the AV data can be transmitted between the AV data transmitter 103 and the AV data receiver 104 equal in ID code over wireless communication. The ID codes A and B given in the wireless communication systems X and Y are fixed to values set at the time of shipping, respectively.

Further, there is proposed, as conventional art, a hot-water supply device wherein a hot-water supply device main body and a remote controller that controls the main body transmit and receive an ID therebetween over communication and wherein only a latest remote controller can be used (Japanese Laid-Open Patent Application No. 7-255089 (1995)). There is also proposed an entryphone wherein one extension telephone transmits its own ID and the other extension telephone that receives this ID uses an ID different from the received ID (Japanese Laid-Open Patent Application No. 11-284754 (1999)).

In the AV data wireless communication system shown in FIG. 38, the AV data wireless transmission can be realized only by a preset combination of AV devices, which disadvantageously restricts a user from enjoying an arbitrary AV data source at an arbitrary location over wireless communication. In the case where a number of AV data receivers each capable of receiving the AV data encrypted by scrambling or the like and transmitted over wireless communication, descrambling the received AV data, and decoding the AV data are present simultaneously, many users can view or listen to the AV data using these AV data receivers. This, however, may possibly, disadvantageously infringe on a copyright of an AV source creator.

The system capable of freely setting codes related to scrambling setting, descrambling, encryption and decryption may disadvantageously, possibly be tapped. In the system that performs retransmission and the like, a plurality of AV data receivers are present and the respective receivers transmit retransmission requests randomly. As a result, a band shortage during concentration of the retransmission requests, the interception of the stable reception of each AV data receiver, and the like may disadvantageously, possibly occur to the system.

The ID management method for the hot-water supply device proposed in Japanese Laid-Open Patent Application No. 7-255089 is executed by the system in which only the latest ID code is valid. Therefore, the same ID code cannot be set to a plurality of devices. Because of the inability to reset the same code, when this ID management method is used for the AV data wireless communication system and the ID is changed once to connect and communicate with the other AV data transmitter or AV data receiver, the ID cannot be returned to the original ID. As a result, it is disadvantageously impossible to hold wireless communication between the original combination of the transmitter and the receiver.

With the ID setting method used for the entryphone provided by Japanese Laid-Open Patent Application No. 11-284754, even when the extension telephones do not use the same ID in a communicable range, one extension telephone may have the same ID as that of the other extension telephone the ID of which is set at the other location. Since this entryphone is hardly moved once it is disposed at one location and this entryphone is hardly turned off, no disadvantage may occur to the above configuration. However, the AV device is often moved and turned off. Therefore, there is a possibility in that a plurality of AV devices have the same ID in the communicable range. Further, it is disadvantageously necessary to check the IDs of the other AV devices and set a different ID to its own AV device whenever communication is held.

### SUMMARY OF THE INVENTION

In view of the above disadvantages, it is an object of the present invention to provide an AV data wireless communication system which can freely construct a system that enables wireless AV data transfer only between an AV data receiver permitted to receive AV data and an AV data transmitter without tapping and random data transmission/reception. It is another object of the present invention to provide a communication apparatus in such an AV data wireless communication system. It is still another object of the present invention to provide an electronic device used in such an AV data wireless communication system.

In order to achieve the above objects, the present invention provides an AV data wireless communication system comprising: an AV data transmitter encrypting an AV data signal including a voice or a picture with a communication key signal, and transmitting the encrypted AV data signal; and an AV data receiver decrypting the received AV data signal, wherein in the case where one of the AV data transmitter and the AV data receiver is defined as a first communication apparatus and the other one is defined as a second communication apparatus, when the first communication apparatus requests the second communication apparatus to transmit the communication key signal, the second communication apparatus generates two or more setting key signals based on the communication key signal of the second communication apparatus, and transmits all of the setting key signals to the first communication apparatus using different transfer mediums, respectively, the different transfer mediums being as many as the setting key signals, and the first communication apparatus decodes the original communication key signal using all of the received setting key signals, and establishes communication with the second communication apparatus.

The present invention also provides an AV data wireless communication system comprising: an AV data transmitter encrypting an AV data signal including a voice or a picture with a communication key signal, and transmitting the encrypted AV data signal; and an AV data receiver decrypting the received AV data signal, wherein in the case where one of the AV data transmitter and the AV data receiver is defined as a first communication apparatus and the other one is defined as a second communication apparatus, when the first communication apparatus requests the second communication apparatus to transmit the communication key signal, the second communication apparatus generates a first setting key signal and a second setting key signal based on the communication key signal of the second communication apparatus, transmits the first key signal to the first communication apparatus using a first transfer medium, and transmits the second setting key signal to the first communication apparatus using a second transfer medium, and the first communication apparatus decodes the original communication key signal using the received first and second setting key signals, stores the communication key signal, and establishes communication with the second communication apparatus.

The present invention also provides a communication apparatus comprising: a first interface connected to a first transfer medium through which an AV data signal including a voice or a picture is transmitted and received; a second interface connected to a second transfer medium other than the first transfer medium; a cipher key storage unit storing a communication key signal for encrypting or decrypting the AV data signal; and a cipher key changeover control unit generating the communication cipher key by performing a specific arithmetic operation, and storing the communication cipher key in the cipher key storage unit, wherein when the communication apparatus requests the communication key signal of a communication apparatus other than the communication apparatus so as to communicate and connect with the other communication apparatus, the communication apparatus receives a first setting key signal and a second setting key signal generated by the other communication apparatus based on the communication key signal at the first interface and the second interface through the first transfer medium and the second transfer medium, respectively, and the cipher key changeover control unit performs the specific arithmetic operation using the received first and second setting key signals, thereby decoding the communication key signal and storing the decoded communication key signal in the cipher key storage unit.

The present invention also provides a communication apparatus comprising: a first interface connected to a first transfer medium through which an AV data signal including a voice or a picture is transmitted and received; a second interface connected to a second transfer medium other than the first transfer medium; a cipher key storage unit storing a communication key signal for encrypting or decrypting the AV data signal; and a setting key signal generation unit which reads out the communication key signal stored in the cipher key storage unit, which performs a specific arithmetic processing, and which generates a first setting key signal and a second setting key signal when determining that the communication cipher key signal is requested, wherein the first setting key signal and the second setting key signal generated by the setting key signal generation unit are outputted to the first transfer medium and the second transfer medium through the first interface and the second interface, respectively.

The present invention also provides an electronic device comprising: an interface connected to a second transfer medium other than a first transfer medium, so as to communicate with a communication terminal that transmits and receives an AV data signal using the first transfer medium; and a setting key signal storage unit that stores a second setting key signal generated based on a communication key signal so as to encrypt or decrypt the AV data signal, wherein the electronic device is employed in the above AV data wireless communication system, and after receiving the second setting key signal transmitted from the second communication apparatus through the interface and storing the second setting key signal in the setting key signal storage unit, the electronic device transmits the second setting key signal stored in the setting key signal storage unit to the first communication apparatus through the interface.

### DESCRIPTION OF THE DRAWINGS

This and other objects and features of the present invention will become clear from the following description, taken in conjunction with the preferred embodiments with reference to the accompanying drawings in which:

FIG. 1 is an illustration for describing an AV data wireless communication system in a first embodiment of the present invention;

FIG. 2 is a block diagram which illustrates the internal configuration of an AV data transmitter in the first embodiment;

FIG. 3 is a block diagram which illustrates the internal configuration of an AV data receiver in the first embodiment;

FIG. 4 is a block diagram which illustrates the internal configuration of an ID management remote controller in the first embodiment;

FIG. 5 is a timing chart which illustrates an operation of the AV data wireless communication system during an ID setting in the first embodiment;

FIG. 6 is a flowchart which illustrates an operation of the AV data wireless communication system during the generation of an encrypted ID code and a decryption code in the first embodiment;

FIG. 7 is a flowchart which illustrates an operation of the AV data transmitter in the first embodiment;

FIG. 8 is a flowchart which illustrates an operation of the ID management remote controller in the first embodiment;

FIGS. 9A to 9E are state transition diagrams which illustrate one example of operations of the AV data wireless communication system in the first embodiment;

FIG. 10 is an illustration for describing an AV data wireless communication system in a second embodiment of the present invention;

FIG. 11 is a block diagram which illustrates the internal configuration of an AV data transmitter in the second embodiment;

FIG. 12 is a block diagram which illustrates the internal configuration of an AV data receiver in the second embodiment;

FIGS. 13A to 13E are state transition diagrams which illustrate one example of operations of the AV data wireless communication system in the second embodiment;

FIG. 14 is a flowchart which illustrates an operation of an AV data transmitter during the generation of the encrypted ID code and the decryption code in a third embodiment of the present invention;

FIG. 15 is a flowchart which illustrates an operation of the AV data receiver during the decryption of the encrypted ID code in the third embodiment;

FIG. 16 is a block diagram which illustrates the internal configuration of an ID management remote controller in a fourth embodiment of the present invention;

FIG. 17 is a flowchart which illustrates an operation of an AV data transmitter in the fourth embodiment;

FIG. 18 is a flowchart which illustrates an operation of the ID management remote controller in the fourth embodiment;

FIG. 19 is a flowchart which illustrates the operation of the ID management remote controller in the fourth embodiment;

FIG. 20 is a flowchart which illustrates an operation of an AV data receiver in the fourth embodiment;

FIG. 21 is a timing chart which illustrates an operation of an AV data wireless communication system during an ID setting in the fourth embodiment;

FIG. 22 is a block diagram which illustrates the internal configuration of an AV data transmitter in a fifth embodiment;

FIG. 23 is a block diagram which illustrates the internal configuration of an AV data receiver in the fifth embodiment;

FIG. 24 is a flowchart which illustrates an operation of the AV data transmitter in the fifth embodiment;

FIG. 25 is a flowchart which illustrates an operation of an ID management remote controller in the fifth embodiment;

FIG. 26 is a flowchart which illustrates the operation of the ID management remote controller in the fifth embodiment;

FIG. 27 is a flowchart which illustrates an operation of the AV data receiver in the fifth embodiment;

FIG. 28 is a timing chart which illustrates an operation of the AV data wireless communication system during an ID setting in the fifth embodiment;

FIG. 29 is a block diagram which illustrates the internal configuration of an AV data receiver in a sixth embodiment of the present invention;

FIG. 30 is a flowchart which illustrates operation of an AV data transmitter in the sixth embodiment;

FIG. 31 is a flowchart which illustrates an operation of the AV data receiver in the sixth embodiment;

FIG. 32 is a flowchart which illustrates an operation of an ID management remote controller in the sixth embodiment;

FIG. 33 is a block diagram which illustrates the internal configuration of the AV data transmitter when an ID code reception side is the AV data transmitter in an AV data wireless communication system in the sixth embodiment;

FIG. 34 is an illustration for describing a memory card to which the present invention is applied;

FIGS. 35A to 35C are illustrations for describing one example of the ID management remote controller according to the present invention;

FIG. 36 is an illustration for describing an AV data wireless communication system in a seventh embodiment of the present invention;

FIG. 37 is a timing chart which illustrates an operation of the AV data wireless communication system during an ID setting in the seventh embodiment;

FIG. 38 is an illustration for describing a conventional AV data wireless communication system;

FIG. 39 is a block diagram which illustrates the internal configuration of a conventional AV data transmitter; and

FIG. 40 is a block diagram which illustrates the internal configuration of a conventional AV data receiver.

### DESCRIPTION OF THE PREFERRED EMBODIMENTS

First Embodiment

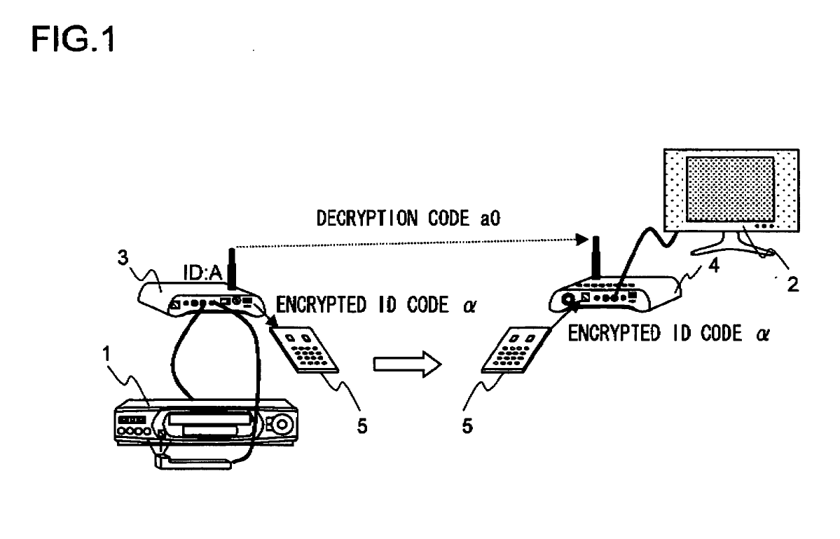

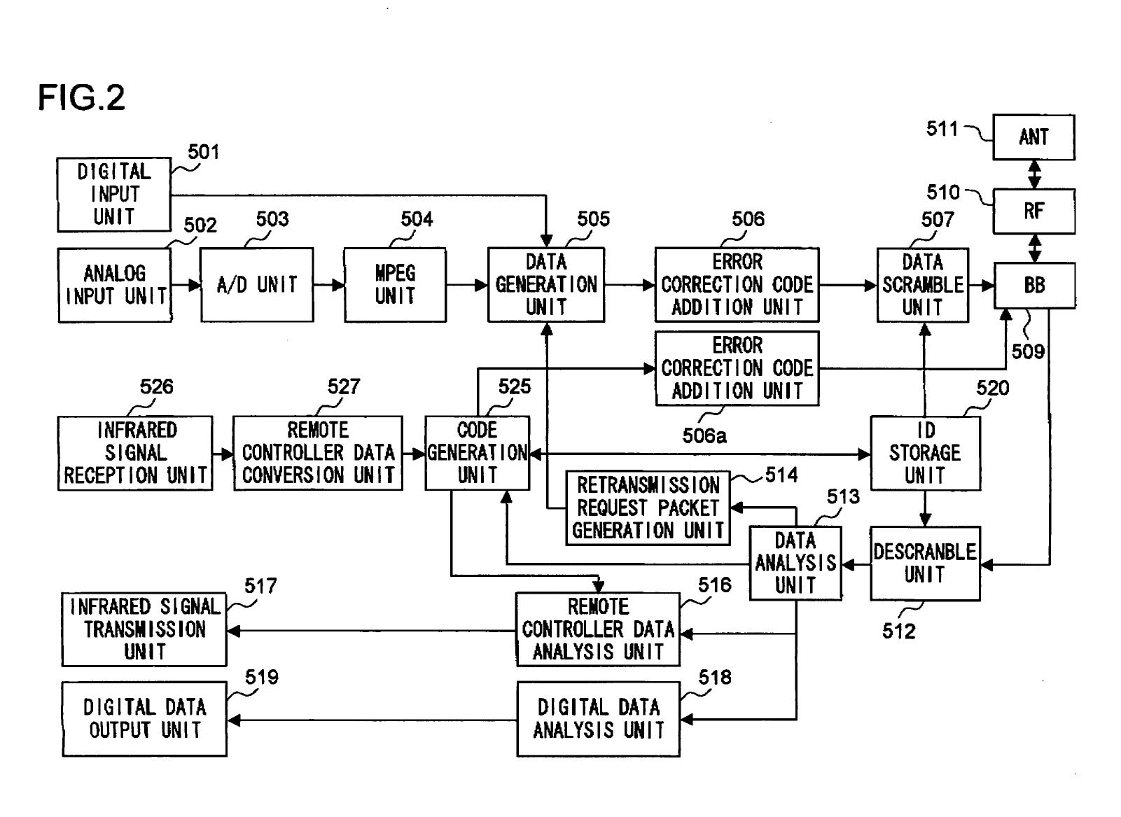

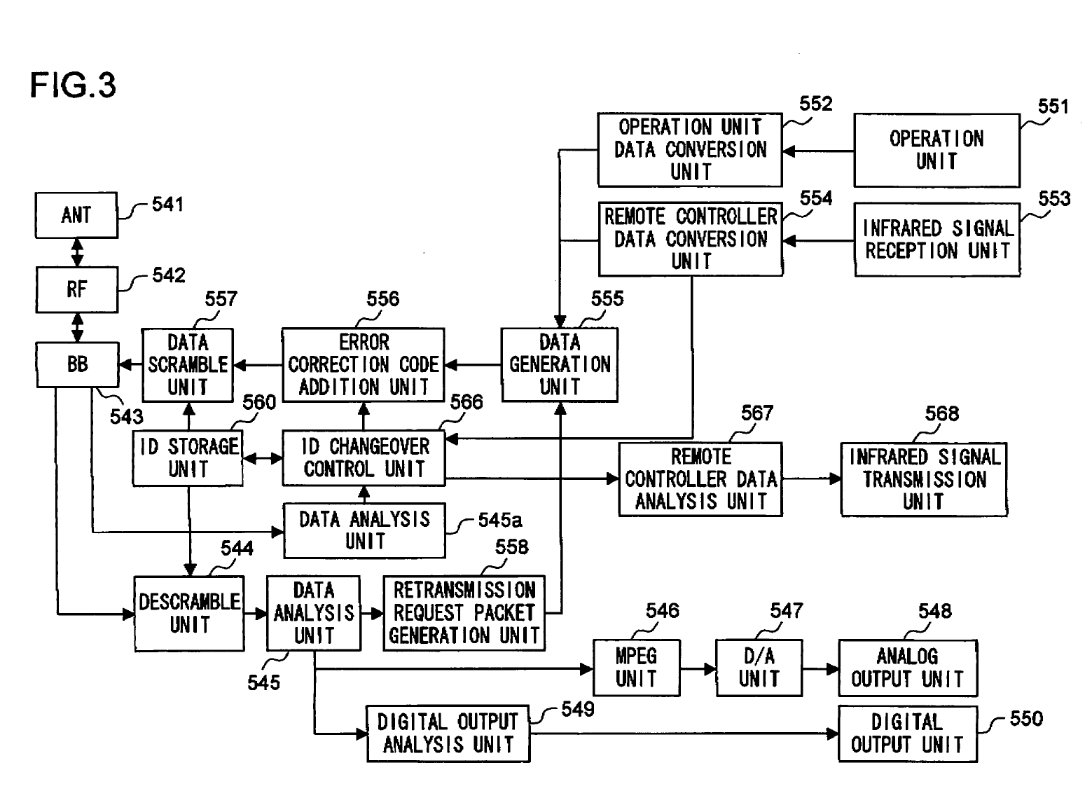

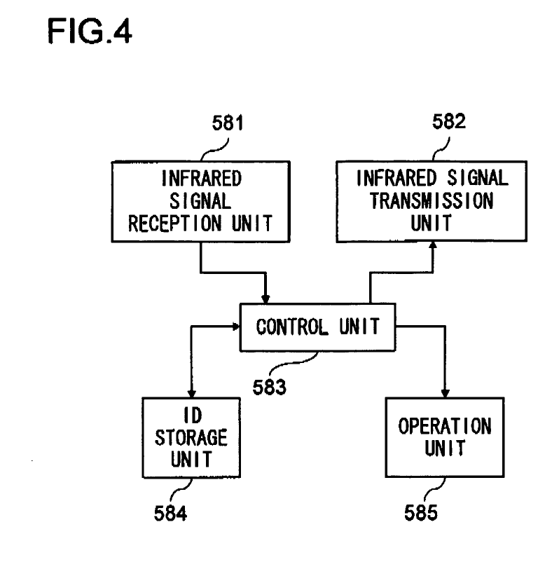

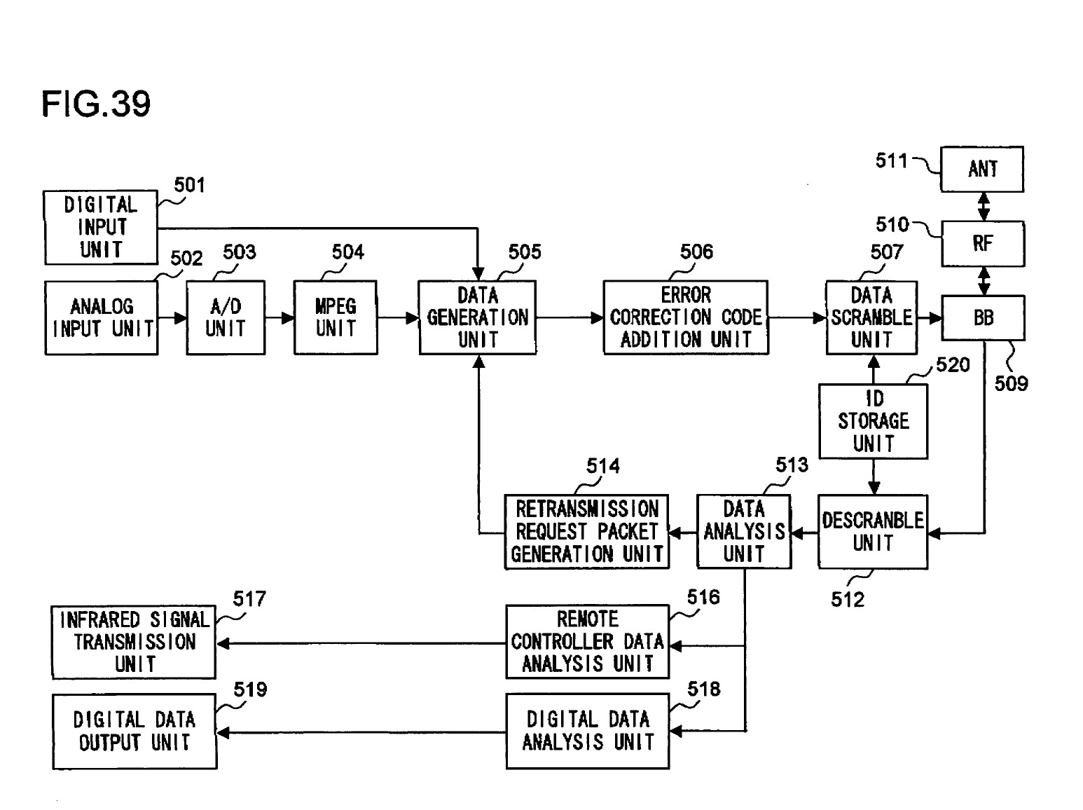

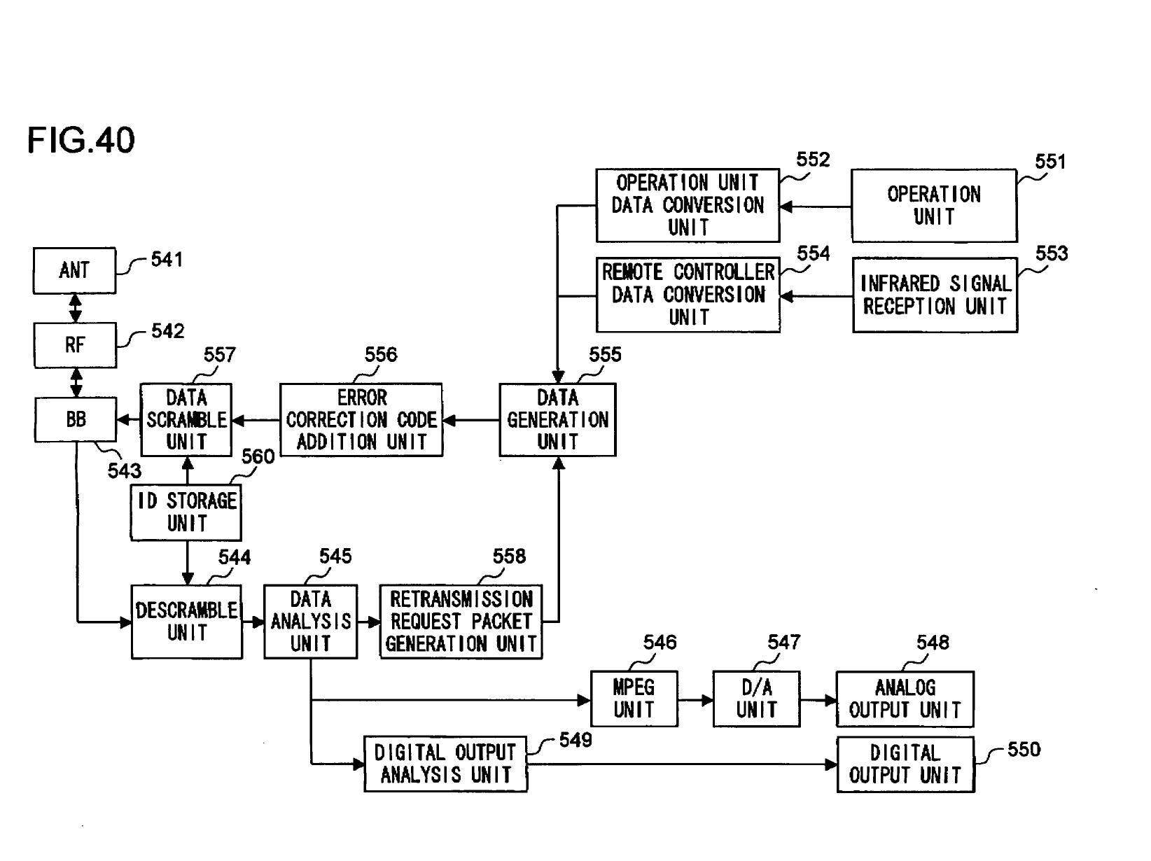

A first embodiment of the present invention will be described hereinafter with reference to the drawings. FIG. 1 is a block diagram which illustrates the configuration of an AV data wireless communication system in the first embodiment. FIGS. 2 and 3 are block diagrams which illustrate internal configurations of an AV data transmitter and an AV data receiver in the first embodiment, respectively. In FIGS. 2 and 3, the same constituent elements as those shown in FIGS. 39 and 40 are denoted by the same reference symbols, respectively, and will not be described herein in detail. FIG. 4 is a block diagram which illustrates the internal configuration of an ID management remote controller.

The AV data wireless communication system shown in FIG. 1 is configured by the AV data transmitter 3 which is connected to an AV source device 1 by a cable, the AV data receiver 4 which is connected to an AV reproduction apparatus 2 by a cable, and a remote controller 5 which holds infrared communication with the AV data transmitter 3 and the AV data receiver 4. Therefore, when a user requests that AV data of the AV source device 1 is reproduced by the AV reproduction apparatus 2 connected to the AV data receiver 4 by the cable while the AV data transmitter 3 encrypts an AV data signal with an ID code A and transmits the encrypted AV data signal, infrared communication is held first between the remote controller 5 and the AV data transmitter 3.

At this time, the AV data transmitter 3 generates an ID code a obtained by encrypting the ID code A and generates a decryption code a0 for decrypting this ID code α. The ID code α is transmitted to the remote controller 5 over infrared communication and stored in the remote controller 5. The decryption code a0 is transmitted from the AV data transmitter 3 over wireless communication. Thereafter, the remote controller 5 which stores the ID code α holds infrared communication with the AV data receiver 4 and the AV data receiver 4 receives the ID code α.

At the same time, the AV data receiver 4 receives the decryption code a0 transmitted from the AV data transmitter 3 over wireless communication, decrypts the ID code α using this decryption code a, and confirms the ID code A. Therefore, the AV data receiver 4 can decrypt the AV data signal transmitted from the AV data transmitter 3 using the ID code A and is permitted to hold AV data communication with the AV data transmitter 3.

In the above AV data wireless communication system, the AV data transmitter 3 is constituted as shown in FIG. 2. The AV data transmitter 3 in this embodiment is equal in configuration to the AV data transmitter shown in FIG. 39 except that the AV data transmitter 3 additionally includes a code generation unit 525 which encrypts the ID code stored in the ID storage unit 520 and which generates the decryption code, an error correction code addition unit 506a which adds an error correction code to the decryption code generated by the code generation unit 525, an infrared signal reception unit 526 which receives the infrared signal from the remote controller 5, and a remote controller data conversion unit 527 which analyzes the infrared signal received by the infrared signal reception unit 526 and which converts the infrared signal to digital data. The remote controller data analysis unit 516 analyzes the digital data supplied from the data analysis unit 513 and the code generation unit 525 and applies the analyzed data to the infrared signal transmission unit 517.

As shown in FIG. 3, the AV data receiver 4 is equal to the AV data receiver shown in FIG. 40 except that the AV data receiver 4 additionally includes an ID changeover control unit 566 which decrypts the encrypted ID code with the received decryption code and which changes over the ID code stored in the ID storage unit 560, a remote controller data analysis unit 567 which analyzes the digital data that serves as a changeover completion signal indicating the completion of the changeover of the ID code by the ID changeover control unit 566, an infrared signal transmission unit 568 which transmits an infrared signal based on the digital data analyzed by the remote controller data analysis unit 567, and a data analysis unit 545a which analyzes the data transmitted from the BB 543 based on the error correction code and which then feeds the analyzed data to the ID changeover control unit 566. At this time, the remote controller data conversion unit 554 directly feeds the digital data received and obtained from the remote controller 5 to the ID changeover control unit 566.

As shown in FIG. 4, the remote controller 5 includes an infrared signal reception unit 581 which receives the infrared signal from the AV data transmitter 3 or the AV data receiver 4, an infrared signal transmission unit 582 which transmits the infrared signal to the AV data transmitter 3 or the AV data receiver 4, a control unit 583 which controls the overall remote controller 5, an ID storage unit 584 which stores the ID code determined by the control unit 583 based on the infrared signal received by the infrared signal reception unit 581, and an operation unit 585.

With the AV data transmitter 3, the AV data receiver 4 and the remote controller 5 thus constituted, operations of the transmitter 3, the receiver 4 and the remote controller 5 at the time of setting the ID code so as to constitute the AV data wireless communication system between the AV data transmitter 3 and the AV data receiver 4 will be described with reference to FIG. 5. FIG. 5 is a timing chart which illustrates operations of the respective apparatuses during this ID code setting.

When, the remote controller 5 is disposed at a position at which the remote controller 5 can hold infrared communication with the AV data transmitter 3, in the remote controller 5, the operation unit 585 is actuated, the control unit 583 generates an ID request signal for requesting the AV data transmitter 3 to transmit the ID code, and the infrared signal transmission unit 582 transmits the ID request signal as an infrared signal to the AV data transmitter 3 (STEP 1). In the AV data transmitter 3, when the infrared signal reception unit 526 receives the infrared signal that is the ID request signal, the remote controller data conversion unit 527 converts the infrared signal to digital data and feeds the digital data to the code generation unit 525, and the AV data transmitter 3 determines that transmission of the ID code is requested (STEP 2).

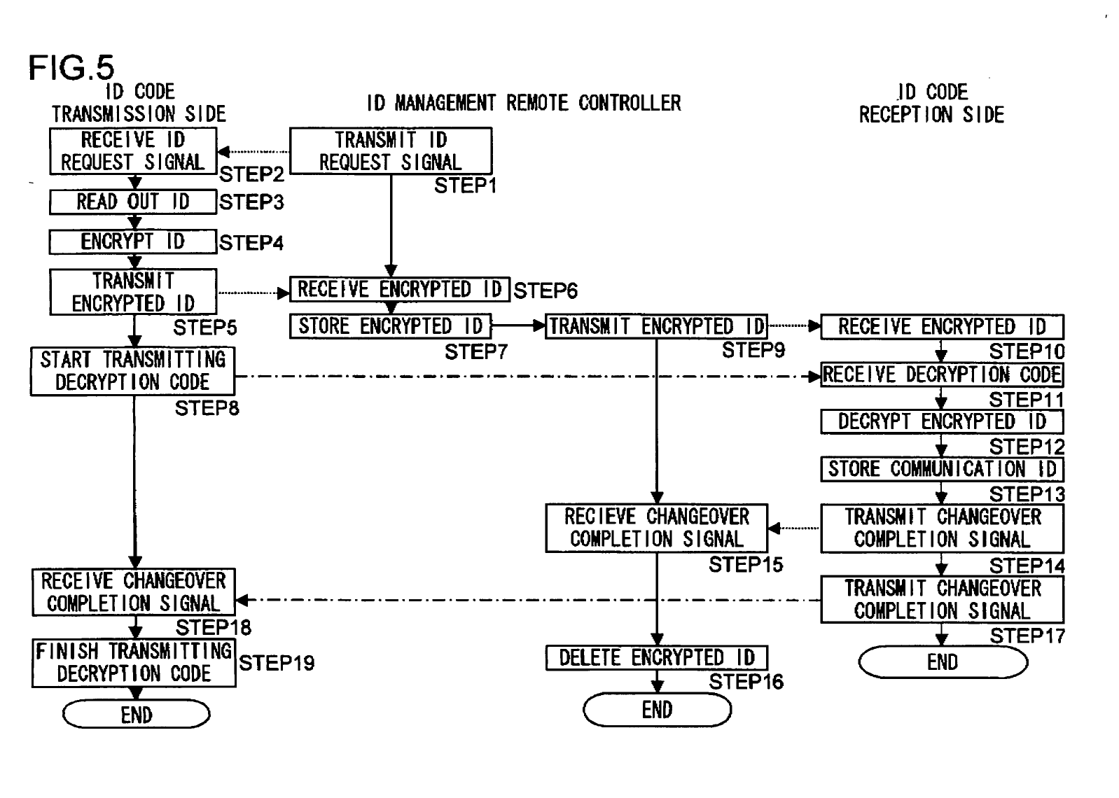

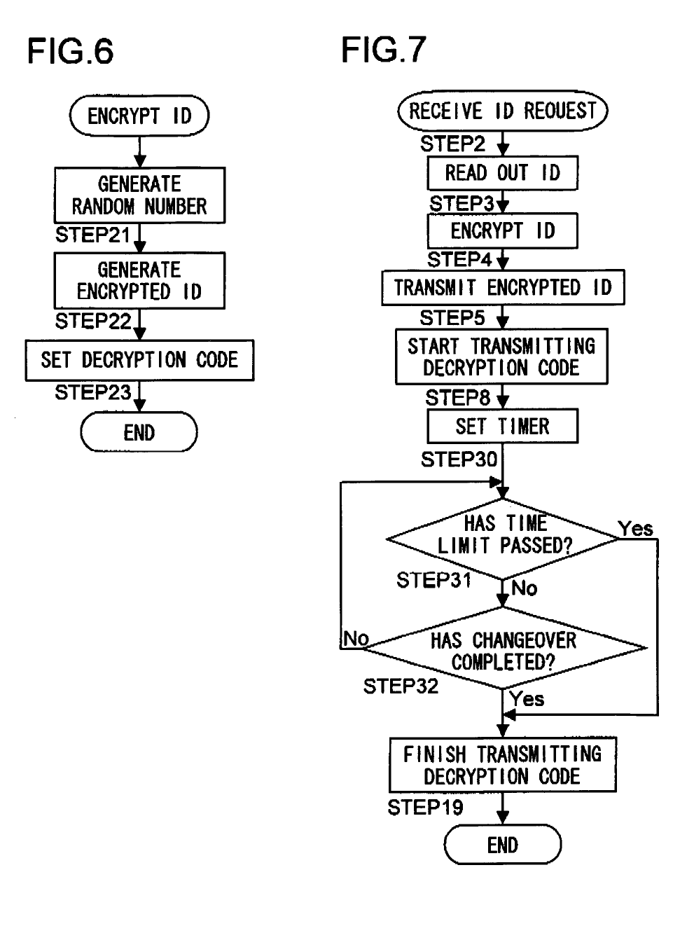

The code generation unit 525 reads out the ID code (hereinafter, referred to as “communication ID code”) stored in the ID storage unit 520 (STEP 3), encrypts this communication ID code, and generates an encrypted ID code and a decryption code for decrypting this encrypted ID code (STEP 4). The communication ID code encryption operation in this step is performed according to, for example, a flowchart of FIG. 6. Namely, the code generation unit 525 generates a random number (STEP 21), and encrypts the communication ID code using this random number to thereby generate the encrypted ID code (STEP 22). Finally, the code generation unit 525 generates the decryption code for decrypting the encrypted ID code to the original communication ID code (STEP 23).

The code generation unit 525 feeds the encrypted ID code thus generated to the infrared signal transmission unit 517 through the remote controller data analysis unit 516 to thereby transmit an infrared signal including information on the encrypted ID code to the remote controller 5 (STEP 5). In the remote controller 5, when the infrared signal reception unit 581 receives this infrared signal (STEP 6), the control unit 583 determines the encrypted ID code based on the infrared signal and stores the encrypted ID code in the ID storage unit 584 (STEP 7).

After transmitting the infrared signal including the encrypted ID code in STEP 5, the AV data transmitter 3 which generates the encrypted ID code and the decryption code applies the decryption code generated simultaneously with the encrypted ID code to the error correction code addition unit 506a, adds the error correction code to the decryption code by the error correction code addition unit 506a, and transmits the resultant decryption code through the BB 509, the RF 510 and the antenna 511 (STEP 8). The AV data transmitter 3 continues to transmit this decryption code until the AV data receiver 4 confirms the reception of the decryption code.

Further, when the remote controller 5 having the encrypted ID code stored in the ID storage unit 584 is disposed at a position at which the remote controller 5 can hold infrared communication with the AV data receiver 4, in the remote controller 5, the operation unit 585 is actuated, the control unit 583 reads out the encrypted ID code from the ID storage unit 584, the infrared signal transmission unit 582 transmits an infrared signal including the encrypted ID code as information (STEP 9). In the AV data receiver 4, when the infrared signal reception unit 553 receives the infrared signal including this encrypted ID code, the remote controller data conversion unit 554 converts the infrared signal to digital data and, then, feeds the digital data to the ID changeover control unit 566 (STEP 10).

When the ID changeover control unit 566 receives the encrypted ID code, the decryption code transmitted continuously from the AV data transmitter 3 is received and fed to the data analysis unit 545a through the antenna 541, the RF 542 and the BB 543, and the data analysis unit 545a analyzes the decryption code using the error correction code and feeds the resultant decryption code to the ID changeover control unit 566 (STEP 11). The ID changeover control unit 566 decrypts the encrypted ID code received in STEP 10 using the decryption code received in STEP 11 (STEP 12).

When the encrypted ID code is decrypted in STEP 12, the ID changeover control unit 566 stores the communication ID code obtained by decrypting the encrypted ID code in the ID storage unit 560 so as to change over the ID code stored in the ID storage unit 560 to the communication ID code (STEP 13). Before this changeover, the communication ID code stored in the ID storage unit 560 is deleted. When the changeover of the communication ID code stored in the ID storage unit 560 is finished, the changeover completion signal indicating the changeover of the ID code is finished is generated by the ID changeover control unit 566 and transmitted, as an infrared signal, from the infrared signal transmission unit 568 through the remote controller data analysis unit 567 to the remote controller 5 (STEP 14).

In the remote controller 5, when the infrared signal reception unit 581 receives the infrared signal that is the changeover completion signal, the infrared signal reception unit 581 feeds the changeover completion signal to the control unit 583 and the control unit 583 determines that the changeover of the communication ID code has been normally performed in the AV data receiver 4 (STEP 15). The control unit 583 deletes the communication ID code stored in the ID storage unit 584 (STEP 16).

In the AV data receiver 4, while the changeover completion signal is transmitted as the infrared signal in STEP 14, the error correction code addition unit 566 adds the error correction code to the changeover completion signal generated by the ID changeover control unit 566. Thereafter, the resultant signal is encrypted by the data scramble unit 557 with the communication ID code thus changed and newly stored in the ID storage unit 560 and transmitted to the AV data transmitter 3 through the BB 543, the RF 542 and the antenna 541 (STEP 17).

When the AV data transmitter 3 receives the changeover completion signal encrypted with the newly changed communication ID code through the antenna 511, the RF 510 and the BB 509, the descramble unit 512 descrambles the encrypted changeover completion signal with the communication ID code stored in the ID storage unit 520 and the data analysis unit 513 determines that the decrypted signal is the changeover completion signal (STEP 18). When the data analysis unit 513 feeds this changeover completion signal to the code generation unit 525, the AV data transmitter determines that the AV data receiver 4 has received the decryption code and completed with the changeover of the communication ID code and finishes the transmission of the decryption code (STEP 19).

By allowing the AV data transmitter 3, the AV data receiver 4 and the remote controller 5 to operate as described above, the AV data receiver 4 can store the communication ID code that the AV data transmitter 3 stores, and can decrypt the AV data signal encrypted with this communication code.

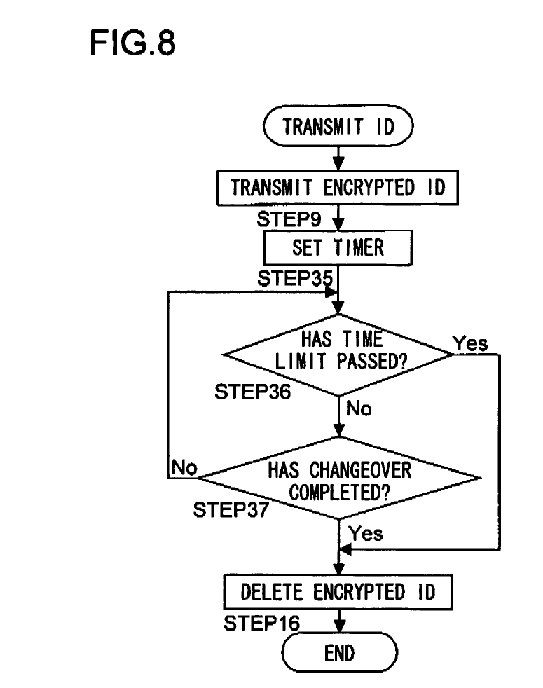

The basic operation performed according to the flowchart of FIG. 5 at the time of changing over the communication ID code in the AV data receiver 4 indicates that the communication ID code has been normally changed over. When a case where the communication ID code has not been normally changed over is considered, the AV data transmitter 3 and the remote controller 5 further perform operations according to flowcharts of FIGS. 7 and 8, respectively. In the flowcharts of FIGS. 7 and 8, the same operations as those in the timing chart of FIG. 5 are denoted by the same reference symbols, respectively, and will not be described in detail.

As shown in the flowchart of FIG. 7, when the AV data transmitter 3 receives the ID request signal from the remote controller 5, the transmitter 3 confirms the communication ID code stored in the ID storage unit 520, generates the encrypted ID code and the decryption code, transmits the encrypted ID code, and starts transmitting the decryption ID code (STEP 2 to STEP 5 and STEP 8). When the AV data transmitter 3 starts transmitting the decryption code generated by the code generation unit 525 through the antenna 511, a timer (not shown) in the code generation unit 525 sets a time limit for the transmission of the decryption code (STEP 30).

The code generation unit 525 determines whether the time limit has passed since the transmission of the decryption code starts (STEP 31). When the code generation unit 525 determines that the time limit has not passed (No in STEP 31), the data analysis unit 513 determines whether the AV data transmitter 3 has received the changeover completion signal transmitted from the AV data receiver 4 (STEP 32). When the data analysis unit 513 determines that the AV data transmitter 3 has received the changeover completion signal (Yes in STEP 32) similarly to STEP 18 shown in FIG. 5, the AV data transmitter 3 finishes transmitting the decryption code (STEP 19). When the code generation unit 525 determines that the time limit has passed (Yes in STEP 31), the processing proceeds to STEP 19 in which the AV data transmitter 3 finishes transmitting the decryption code. When the data analysis unit 513 determines that the AV data transmitter 3 has not received the changeover completion signal (No in STEP 32), the processing proceeds to STEP 31 in which it is determined whether the time limit has passed.

As shown in the flowchart of FIG. 8, when the remote controller 5 transmits the encrypted ID code stored in the ID storage unit 584 to the AV data receiver 4 (STEP 9), time limit for storing the encrypted ID code in the ID storage unit 584 is set (STEP 35). The control unit 583 determines whether the time limit has passed after the transmission of the encrypted ID code (STEP 36). When the time limit has not passed (No in STEP 36), the control unit 583 determines whether the remote controller 5 has received the changeover completion signal transmitted from the AV data receiver 4 (STEP 37).

When the control unit 583 determines that the remote controller 5 has received the changeover completion signal similarly to STEP 15 shown in FIG. 5 (Yes in STEP 37), the control unit 583 deletes the communication ID code stored in the ID storage unit 584 (STEP 16). When it is determined that the time limit has passed (Yes in STEP 36), the processing proceeds to STEP 16 in which the control unit 583 deletes the encrypted ID code from the ID storage unit 584. When the control unit 583 does not determine that the remote controller 5 has received the changeover completion signal (No in STEP 37), the processing proceeds to STEP 36 in which the control unit 583 determines whether the time limit has passed.

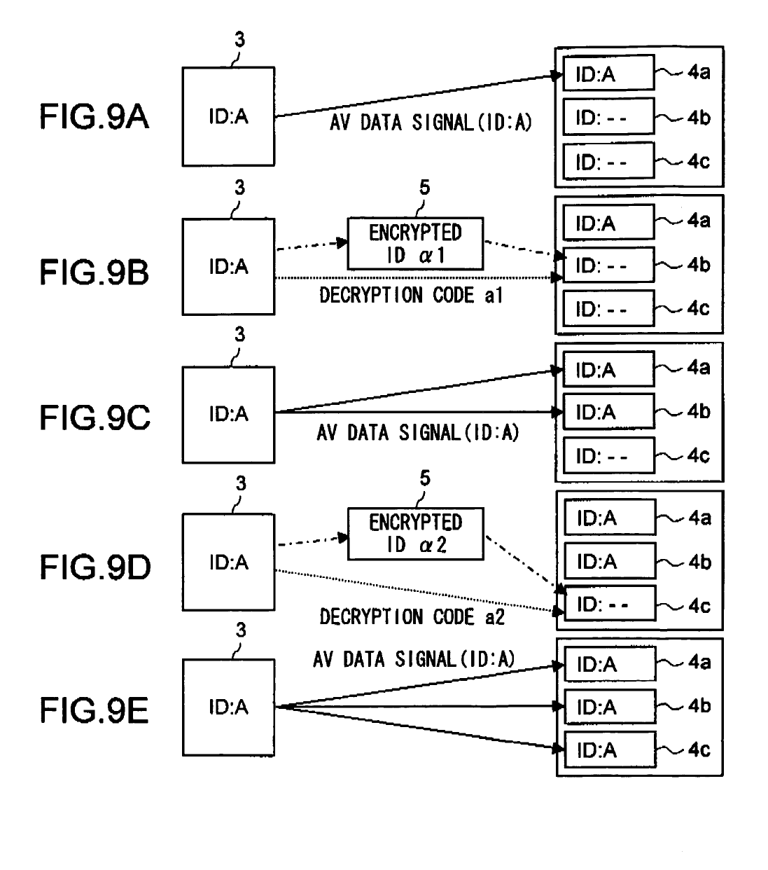

An example of operations of the AV data wireless communication system by one AV data transmitter 3 and a plurality of AV data receivers 4 during the ID code setting will be described with reference to state transition diagrams of FIGS. 9A to 9E.

As shown in FIG. 9A, it is assumed herein that the AV data transmitter 3 having the ID code A stored in the ID storage unit 520 as the communication ID code, the AV data receivers 4a to 4c, and the remote controller 5 are present. It is also assumed herein that the AV data receiver 4a already stores the ID code A in the ID storage unit 560 as the communication ID code and is in a state where the AV data receiver 4a can receive the AV data signal from the AV data transmitter 3.

When the remote controller 5 transmits the ID request signal while the AV data signal encrypted with the ID code A is transmitted from the AV data transmitter 3 and received by the AV data receiver 4a, an ID code α1 obtained by encrypting the ID code A is transmitted from the AV data transmitter 3 to the remote controller 5 and stored in the ID storage unit 584 of the remote controller 5 as shown in FIG. 9B. In addition, simultaneously with the generation of the ID code α1, the code generation unit 525 of the AV data transmitter 3 generates a decryption code a1.

The remote controller 5 having the ID code α1 stored in the ID storage unit 584 holds infrared communication with the AV data receiver 4b, whereby the AV data receiver 4b receives the ID code α1. And the AV data receiver 4b receives the decryption code a1 transmitted from the AV data transmitter 3. In the AV data receiver 4b, the ID code α1 and the decryption code a1 thus received are fed to the ID changeover control unit 566, the ID changeover control unit 566 decrypts the ID code α1 using the decryption code a1, and the ID code A is thereby obtained as the communication ID code.

Accordingly, as shown in FIG. 9C, the AV data receiver 4b stores the ID code A in the ID storage unit 560 and can decrypts the AV data signal transmitted from the AV data transmitter 3 and encrypted with the ID code A. Namely, the AV data receivers 4a and 4b can receive the AV data signal from the AV data transmitter 3. At this time, the ID code α1 stored in the ID storage unit 584 of the remote controller 5 is deleted. Thereafter, when the remote controller 5 transmits the ID request signal to the AV data transmitter 3, an ID code a2 obtained by encrypting the ID code A is transmitted to the AV data receiver 4c through the remote controller 5 and a decryption code a2 generated simultaneously with the ID code a2 is transmitted to the AV data receiver 4c over wireless communication, and the AV data receiver 4c receives the ID code a2 and the decryption code a2 as shown in FIG. 9D.

The AV data receiver 4c decrypts the ID code a2 using the decryption code a2 to thereby obtain the ID code A, and stores the ID code A as the communication ID code as shown in FIG. 9E. At this time, the ID code a2 stored in the ID storage unit 584 of the remote controller 5 is deleted. Therefore, the AV data receiver 4c can decrypt the AV data signal transmitted from the AV data transmitter 3 and encrypted with the ID code A. That is, the AV data receivers 4a to 4c can receive the AV data signal from the AV data transmitter 3.

By these operations, the AV data receivers 4 that can hold data communication with the AV data transmitter 3 can be limited to those which can communicate with the remote controller 5. In addition, the AV data receivers 4 that can hold data communication with the AV data transmitter 3 are limited to those which can communicate with the remote controller 5 and decrypt the encrypted ID code using the decryption code from the AV data transmitter 3.

In this embodiment, when the remote controller 5 does not receive the changeover completion signal, the encrypted ID code stored in the remote controller 5 is deleted after the passage of predetermined time since the encrypted ID code is transmitted to the AV data receiver 4. Alternatively, the encrypted ID code stored in the remote controller 5 may be deleted immediately after the transmission of the encrypted ID code to the AV data receiver 4 or after the passage of the predetermined time since the encrypted ID code is stored in the ID storage unit 584 of the remote controller 5.

In this embodiment, when the remote controller 5 does not receive the changeover completion signal, the transmission of the decryption code is finished after the passage of predetermined time since the transmission of the decryption code is started. Alternatively, the transmission of the decryption code may be finished when the other operation such as the reception of the other ID request signal is performed after the passage of the predetermined time. In this embodiment, the AV data receiver 4 receives the decryption code after receiving the encrypted ID code. Alternatively, the AV data receiver 4 may receive the encrypted ID code after confirming the reception of the decryption code.

Second Embodiment

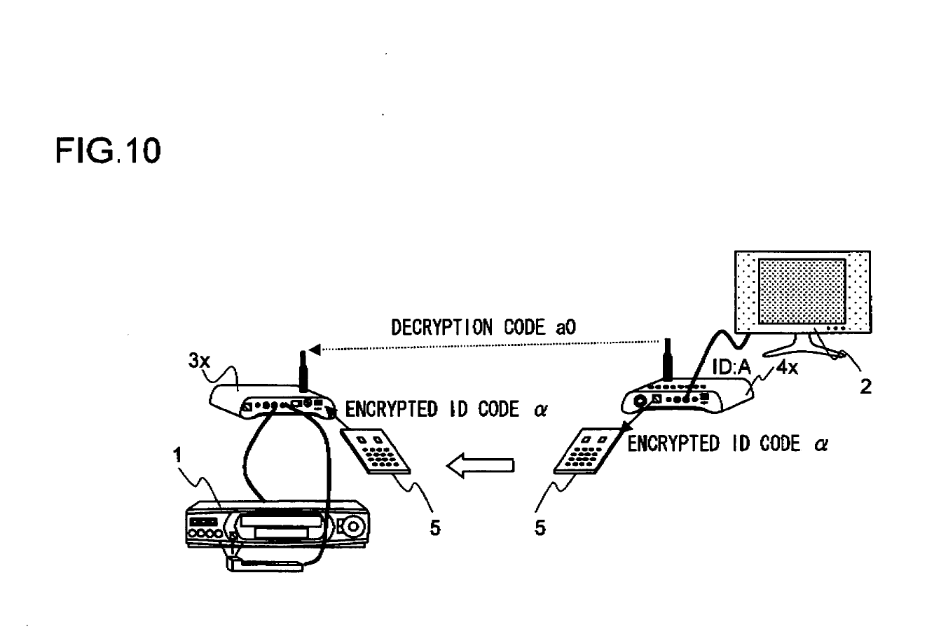

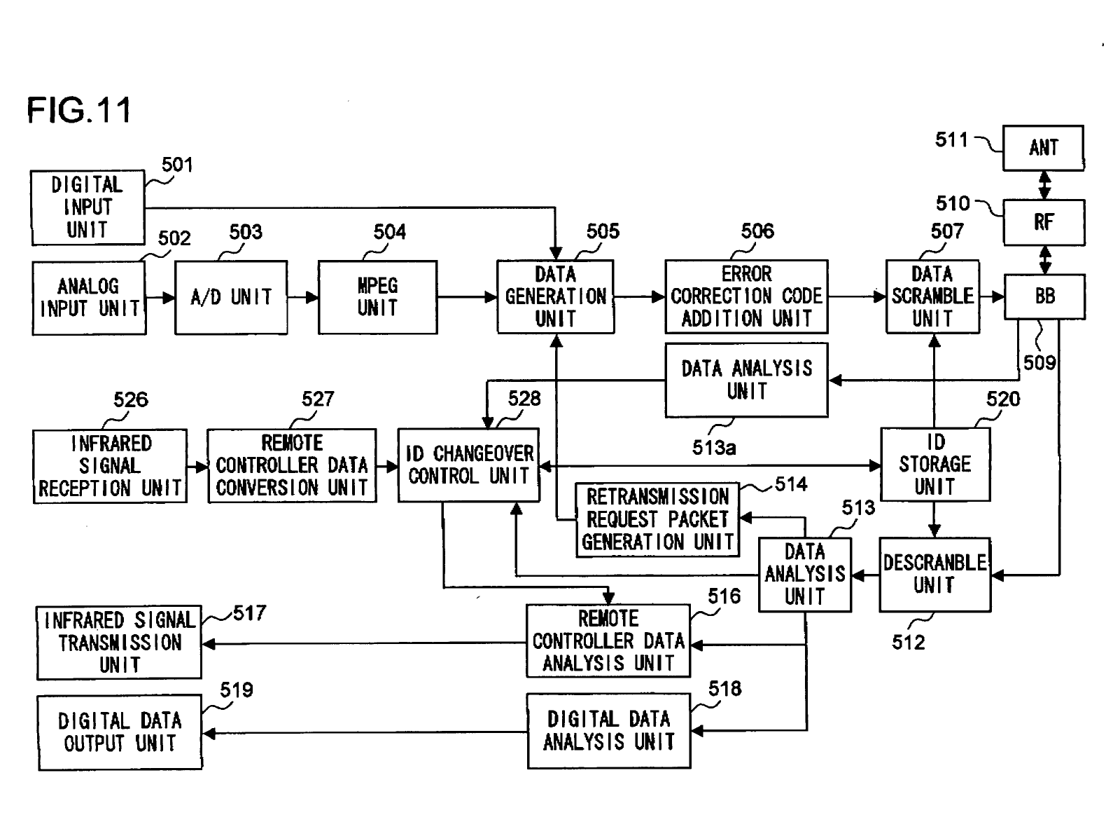

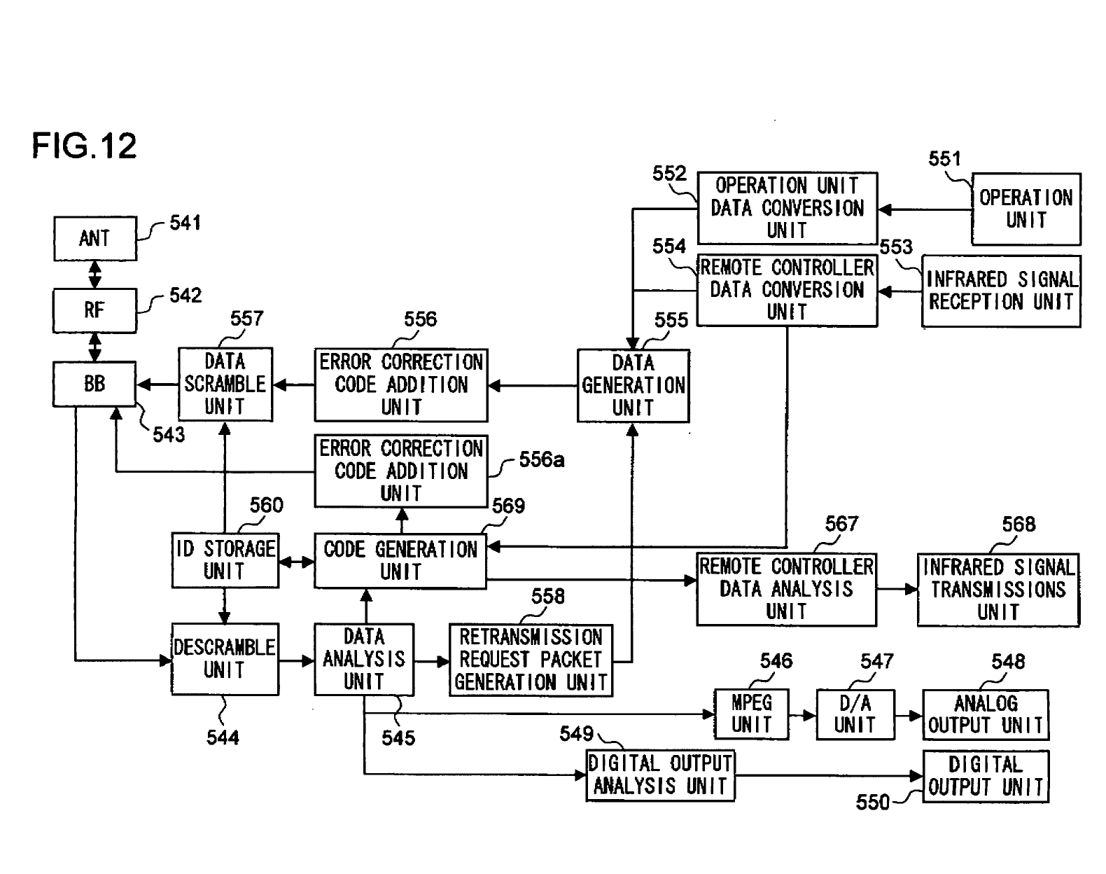

A second embodiment of the present invention will be described with reference to the drawings. FIG. 10 is a block diagram which illustrates the configuration of an AV data wireless communication system in the second embodiment. FIGS. 11 and 12 are block diagrams which illustrate internal configurations of an AV data transmitter and an AV data receiver in the second embodiment, respectively. In FIGS. 11 and 12, the same constituent elements as those shown in FIGS. 2 and 3 are denoted by the same reference symbols as those in FIGS. 2 and 3 and will not be described herein in detail. An ID management remote controller 5 is constituted as shown in FIG. 4 similarly to the first embodiment.

The AV data wireless communication system shown in FIG. 10, like the AV data wireless communication system shown in FIG. 1, is configured by an AV data transmitter 3x connected to the AV source device 1 by a cable, an AV data receiver 4x connected to the AV reproduction apparatus 2 by a cable, and the remote controller 5 which holds infrared communication with the AV data transmitter 3x and the AV data receiver 4x. In the AV data wireless communication system thus constituted, when the user requests that the AV data of the AV source device 1 is reproduced by the AV reproduction apparatus 2 connected to the AV data receiver 4x by the cable, infrared communication is held first between the remote controller 5 and the AV data receiver 4x.

At this time, the AV data receiver 4x generates the encrypted ID code α obtained by encrypting the communication ID code A and the decryption code a0 for decrypting the encrypted ID code α, transmits the encrypted ID code α to the remote controller 5 over infrared communication, and transmits the decryption code a0 to the AV data transmitter 3x over wireless communication. After storing the encrypted ID code α, the remote controller 5 which stores the encrypted ID code α holds infrared communication with the AV data transmitter 3x and the AV data transmitter 3x receives the ID code α.

The AV data transmitter 3x receives the decryption code a0 transmitted from the AV data receiver 4x over wireless communication, decrypts the encrypted ID code α using this decryption code a, and confirms the communication ID code A. Accordingly, the AV data transmitter 3x can encrypt the AV data signal with the communication ID code A and transmit the encrypted AV data signal. That is, the AV data transmitter 3x which holds the communication ID code A can encrypt this AV data signal with the communication ID code A, and AV data communication between the AV data transmitter 3x and the AV data receiver 4x is permitted.

In this AV data wireless communication system, the AV data transmitter 3x is constituted as shown in FIG. 11. Namely, the AV data transmitter 3x differs from that shown in FIG. 2 in that the AV data transmitter 3x does not include the ID code generation unit 525 and the error correction code addition unit 506a but additionally includes an ID changeover control unit 528 that decrypts the ID code encrypted with the received decryption code and that changes over the ID code stored in the ID storage unit 520, and a data analysis unit 513a that analyzes the data fed from the BB 509 based on the error correction code and that feeds the analyzed data to the ID changeover control unit 528. With this constitution, the digital data from the remote controller data conversion unit 527 is fed to the ID changeover control unit 528 and the digital data from the ID changeover control unit 528 is fed to the remote controller data analysis unit 516.

The AV data receiver 4x is constituted as shown in FIG. 12. Namely, the AV data receiver 4x differs from that shown in FIG. 3 in that the AV data receiver 4x does not include the data analysis unit 545a and the ID changeover control unit 566 but additionally includes a code generation unit 569 that encrypts the ID code stored in the ID storage unit 560 and that generates the decryption code and an error correction code addition unit 556a that adds the error correction code to the decryption code generated by the code generation unit 525. With this constitution, the digital data from the remote controller data conversion unit 554 is fed to the code generation unit 569 and the digital data from the code generation unit 569 is fed to the remote controller data analysis unit 567.

As described above, the AV data transmitter 3x is constituted to additionally include the same blocks as those added to the AV data receiver 4 (FIG. 3) from the constitution shown in FIG. 40 in the first embodiment. The AV data receiver 4x is constituted to additionally include the same blocks as those added to the AV data transmitter 3 (FIG. 2) from the constitution shown in FIG. 39 in the first embodiment. Therefore, when the communication ID code is set, the AV data transmitter 3x operates similarly to the AV data receiver 4 in the first embodiment and the AV data receiver 4x operates similarly to the AV data transmitter 3 in the first embodiment.

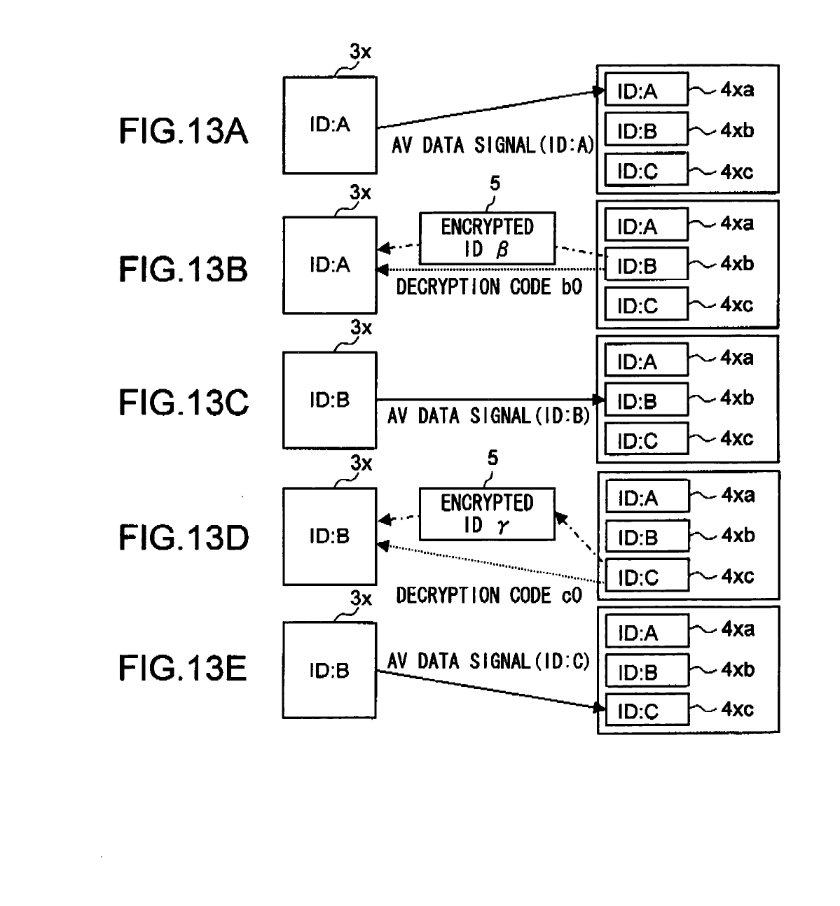

That is, the AV data transmitter 3x performs operations in STEP 10 to STEP 14 and STEP 17 in the timing chart of FIG. 5 and the AV data receiver 4x performs operations in STEP 2 to STEP 5, STEP 8, STEP 18 and STEP 19 in the timing chart of FIG. 5. An example of operations of the AV data wireless communication system by one AV data transmitter 3x and a plurality of AV data receivers 4xa to 4xc during the ID code setting will be described with reference to state transition diagrams of FIGS. 13A to 13E.

As shown in FIG. 13A, it is assumed herein that the AV data receivers 4xa to 4xc having ID codes A to C stored in the ID storage units 560 as communication ID codes, respectively, the AV data transmitter 3x, and the remote controller 5 are present. It is also assumed herein that the AV data transmitter 3x already stores the ID code A in the ID storage unit 520 as the communication ID code and encrypts the AV data signal with the ID code A and transmits the encrypted AV data signal. Therefore, the AV data receiver 4xa is in a state where the AV data receiver 4xa can receive the AV data signal from the AV data transmitter 3x.

When the remote controller 5 transmits the ID request signal to the AV data receiver 4xb, the ID request signal is received by the infrared signal reception unit 553 of the AV data receiver 4xb and fed to the code generation unit 569 through the remote controller data conversion unit 554. The code generation unit 569 of the AV data receiver 4xb reads out the ID code B stored in the ID storage unit 560 and generates an ID code β obtained by encrypting the ID code B and a decryption code b. At this time, similarly to the first embodiment, the AV data receiver 4xb operates according to the flowchart of FIG. 6. As shown in FIG. 13B, the infrared signal transmission unit 568 transmits the ID code β to the remote controller 5 through the remote controller data analysis unit 567 of the AV data receiver 4xb. The ID code β is thus stored in the ID storage unit 584 of the remote controller 5.

The remote controller 5 which thus stores the ID code β transmits the ID code β as an infrared signal to the AV data transmitter 3x. In the AV data transmitter 3x, when the infrared signal reception unit 526 receives this infrared signal, the remote controller data conversion unit 527 converts the infrared signal to digital data and feeds the ID code β to the ID changeover control unit 528.

Further, in the AV data receiver 4xb, the error correction code addition unit 556a adds the error correction code to the decryption code b0 generated by the code generation unit 569 and transmits the resultant decryption code b0 to the AV data transmitter 3x through the BB 543, the RF 542 and the antenna 541. When the AV data transmitter 3x receives the decryption code b, the data analysis unit 513a, to which the decryption code b0 is fed through the antenna 511, the RF 510 and the BB 509, determines that the data is the decryption code b0 and feeds the decryption code b0 to the ID changeover control unit 528.

In the AV data transmitter 3x, when the ID code β and the decryption code b0 thus received are fed to the ID changeover control unit 528, the ID changeover control unit 528 decrypts the ID code β using the decryption code b0 to thereby obtain the ID code B as the communication ID code. Accordingly, as shown in FIG. 13C, the AV data transmitter 3x changes over the ID code A to the ID code B and stores the ID code B in the ID storage unit 520.

The AV data signal transmitted from the AV data transmitter 3x and encrypted with the ID code B is decrypted by the AV data receiver 4xb. Namely, the AV data signal from the AV data transmitter 3x cannot be received by the AV data receiver 4xa and can be received only by the AV data receiver 4xb. Further, the ID code β stored in the ID storage unit 584 of the remote controller 5 is deleted.

Thereafter, similarly to the above, when the remote controller 5 transmits the ID request signal to the AV data receiver 4xc, an ID code γ obtained by encrypting the ID code C is transmitted to the AV data transmitter 3x through the remote controller 5, a decryption code cO generated simultaneously with the ID code γ is transmitted to the AV data transmitter 3x over wireless communication, and the AV data transmitter 3x receives the ID code γ and the decryption code c0 as shown in FIG. 13D.

In the AV data transmitter 3x, the ID code γ is decrypted using the decryption code c0 to thereby obtain the ID code C. As shown in FIG. 13E, the ID code B is changed over to this ID code C and the ID code C is stored in the ID storage unit 520 as the communication ID code. At this time, the ID code γ stored in the ID storage unit 520 of the remote controller 5 is deleted. Accordingly, the AV data signal, which is encrypted with the ID code C and which is transmitted from the AV data transmitter 3x, cannot be received by the AV data receiver 4xb and can be received only by the AV data receiver 4xc.

By allowing the AV data transmitter and AV data receivers to perform operations as described above, the remote controller 5 can designate and limit the AV data receiver 4x that can communicate data with the AV data transmitter 3x in a one-to-one correspondence. In this embodiment, the AV data receiver 4x may operate according to the flowchart of FIG. 7 and the remote controller 5 may operate according to the flowchart of FIG. 8. Further, the encrypted ID code stored in the ID storage unit 584 of the remote controller 5 may be deleted immediately after the transmission of the encrypted ID code or after passage of predetermined time since the encrypted ID code is stored in the ID storage unit 584 of the remote controller 5.

In this embodiment, the transmission of the decryption code may be finished when the other operation is performed. Further, in this embodiment, the AV data transmitter 3x may receive the decryption code after receiving the encrypted ID code or may receive the encrypted ID code after confirmation of the reception of the decryption code.

Third Embodiment

A third embodiment of the present invention will be described with reference to the drawings. In the third embodiment, similarly to the first embodiment, the AV data wireless communication system constituted as shown in FIG. 1, the AV data transmitter constituted as shown in FIG. 2, the AV data receiver constituted as shown in FIG. 3, and the ID management remote controller constituted as shown in FIG. 4 are employed. The ID code setting operation is the same as that in the first embodiment.

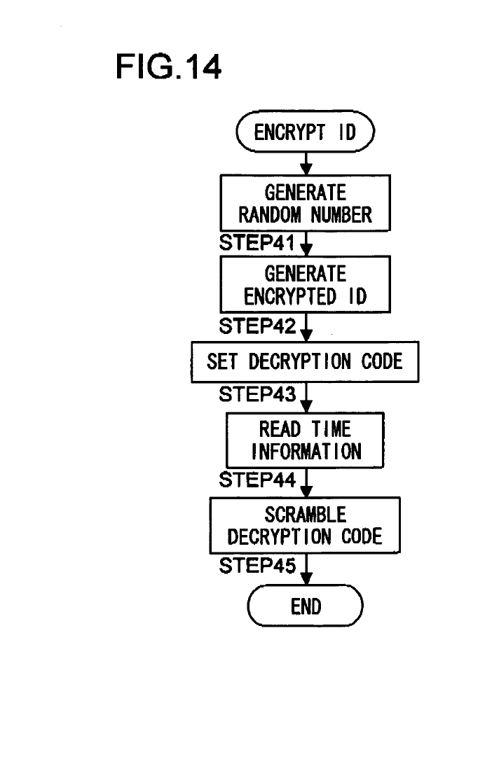

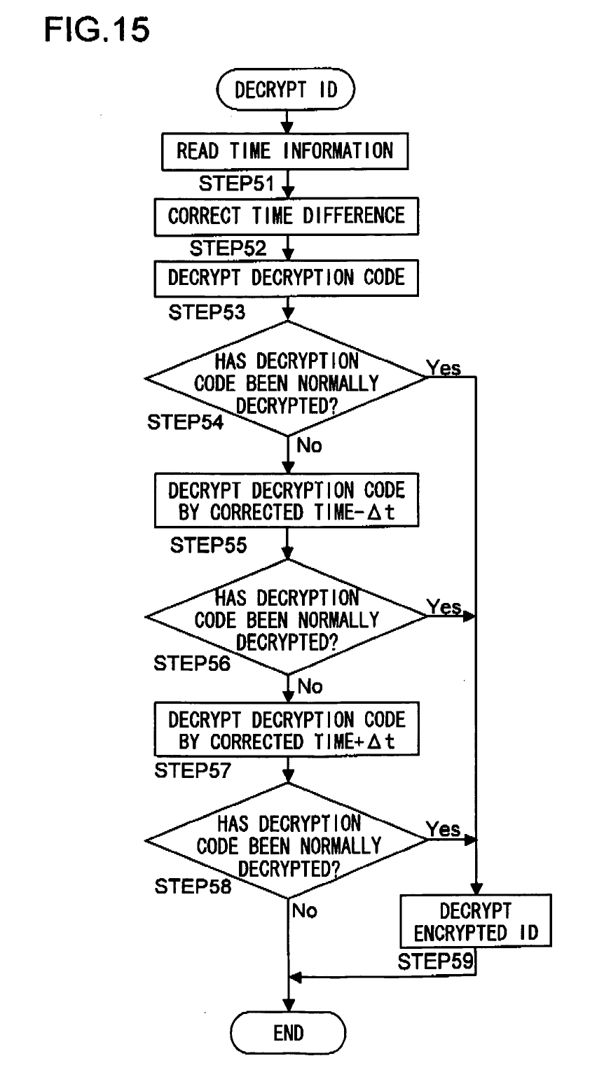

In the AV data wireless communication system in this embodiment, differently from the first embodiment, when the AV data transmitter 3 generates the encrypted ID code, the AV data transmitter 3 operates according to the flowchart of FIG. 14 and when the AV data receiver 4 performs decryption of the encrypted ID code, the AV data receiver 4 operates according to the flowchart of FIG. 15. Therefore, the operation of the AV data transmitter 3 for generating the encrypted ID code and the operation of the AV data receiver 4 for decrypting the encrypted ID code will be described hereinafter.

The AV data transmitter 3 and the AV data receiver 4 have timers (not shown) included in the code generation unit 525 and the ID changeover control unit 566, respectively, and set to synchronize time. The synchronization of the timers (not shown) in the code generation unit 525 and the ID changeover control unit 566 is made by holding communication of unencrypted data between the AV data transmitter 3 and the AV data receiver 4 at predetermined time intervals.

With this constitution, when the infrared signal reception unit 526 of the AV data transmitter 3 receives the ID request signal from the remote controller 5, the code generation unit 525 starts generating the encrypted ID code and the decryption code. First, the code generation unit 525 generates a random number (STEP 41), encrypts the communication ID code read out from the ID storage unit 520 according to this random number to thereby generate the encrypted ID code (STEP 42), and sets the decryption code for decrypting the encrypted ID code (STEP 43).

When the code generation unit 525 generates the encrypted ID code and the decryption code, the timer (not shown) recognizes present time as time information (STEP 44). Using this time information, the code generation unit 525 encrypts the decryption code (STEP 45). Thereafter, the encrypted ID code generated in STEP 42 is transmitted from the AV data transmitter 3 to the remote controller 5 over infrared communication, transmitted from the remote controller 5 to the AV data receiver 4 over infrared communication, and fed to the ID changeover control unit 566 of the AV data receiver 4. Further, the decryption code encrypted using the time information in STEP 45 is transmitted from the AV data transmitter 3 to the AV data receiver 4 over wireless communication and fed to the ID changeover control unit 566.

When the encrypted ID code and the decryption code are fed to the ID changeover control unit 566 of the AV data receiver 4, the ID changeover control unit 566 recognizes the present time using the timer (not shown) as time information (STEP 51). The ID changeover control unit 566 generates time information corrected by a time difference equal to transmission time for the transmission of the decryption code from the AV data transmitter 3 to the AV data receiver 4 based on header information on the received decryption code (STEP 52). The ID changeover control unit 566 decrypts the encrypted decryption code using the time difference-corrected time information (STEP 53).

The ID changeover control unit 566 determines whether the decryption code has been normally decrypted (STEP 54). When it is determined that the decryption code has not been normally decrypted (No in STEP 54), the ID changeover control unit 566 corrects the time information, which has been subjected to the time difference correction in STEP 52, by −Δt and, then, decrypts the decryption code using the corrected time information (STEP 55). This At is intended to correct lower bits of the time information. The ID changeover control unit 566 further determines whether the decryption code has been normally decrypted (STEP 56). When it is determined that the decryption code has not been normally decrypted (No in STEP 56), the ID changeover control unit 566 corrects the time information, which has been subjected to the time difference correction in STEP 52, by +Δt and, then, decrypts the decryption code using the corrected time information (STEP 57). The ID changeover control unit 56 similarly determines whether the decryption code has been normally decrypted (STEP 58).

When the decryption code has been normally decrypted in one of STEP 54, STEP 56 and STEP 58 (Yes), the ID code changeover control unit 566 decrypts the encrypted ID code using the decryption code thus decrypted (STEP 59). When the encrypted ID code is decrypted and the communication ID code is obtained, the ID code stored in the ID storage unit 560 is changed over to the obtained communication ID code and the communication ID code is stored in the ID storage unit 560. When the decryption code has not been normally decrypted (No in STEP 58), the AV data receiver 4 finishes the operation. At this time, the AV data receiver 4 may generate an error signal indicating that the decryption code has not been normally decrypted and transmit the error signal to the AV data transmitter 3 and the remote controller 5 over wireless communication and infrared communication, respectively, so as to notify the transmitter 3 and the controller 5 that the decryption code has not been normally decrypted.

With the above operations, the decryption code is encrypted with a different value corresponding to the time when the decryption code is transmitted. Therefore, the decryption code can take different values whenever the code is transmitted. It is thereby possible to prevent duplication of the ID code or the like. Further, in the third embodiment, similarly to the first embodiment, the AV data wireless communication system is constituted so that the AV data transmitter transmits the ID code to the AV data receiver. Alternatively, the AV data wireless communication system may be constituted so that the AV data receiver transmits the ID code to the AV data transmitter similarly to the second embodiment. In this case, the AV data receiver operates according to the flowchart of FIG. 14 and the AV data transmitter operates according to the flowchart of FIG. 15.

Fourth Embodiment

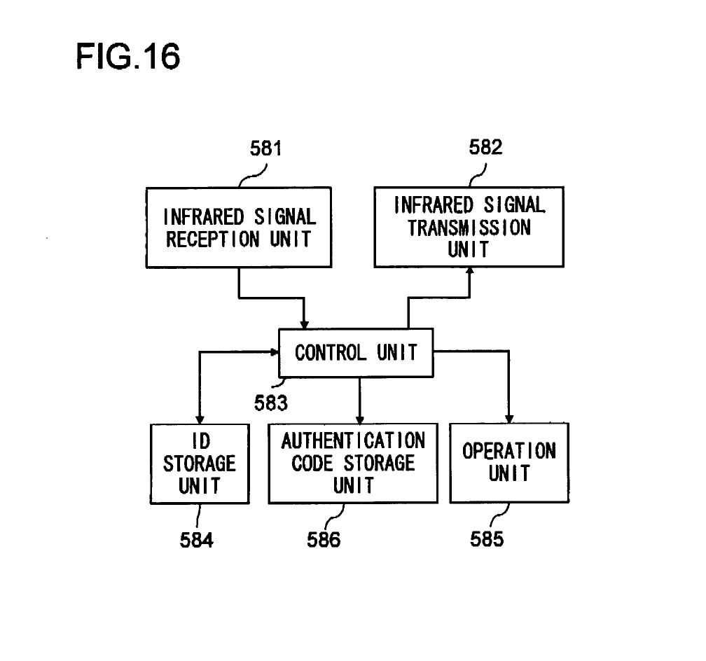

A fourth embodiment of the present invention will be described with reference to the drawings. FIG. 16 is a block diagram which illustrates the internal configuration of an ID management remote controller in the fourth embodiment. In this embodiment, similarly to the first embodiment, the AV data wireless communication system constituted as shown in FIG. 1, the AV data transmitter constituted as shown in FIG. 2, and the AV data receiver constituted as shown in FIG. 3 are employed. In FIG. 16, constituent elements of the remote controller used for the same purposes as those of the remote controller shown in FIG. 4 are denoted by the same reference symbols as those in FIG. 4 and will not be described herein in detail.

In this embodiment, as shown in FIG. 16, the remote controller 5a includes an authentication code storage unit 586 that stores an authentication code as well as the constituent elements shown in FIG. 4, and the control unit 583 confirms the authentication code stored in the authentication code storage unit 586. With this constitution, the remote controller 5a has the authentication code. Therefore, when the authentication code is transmitted from the remote controller 5a over infrared communication and received by the AV data transmitter 3 and the AV data receiver 4, the AV data transmitter 3 and the AV data receiver 4 authenticate the remote controller 5a based on this authentication code.

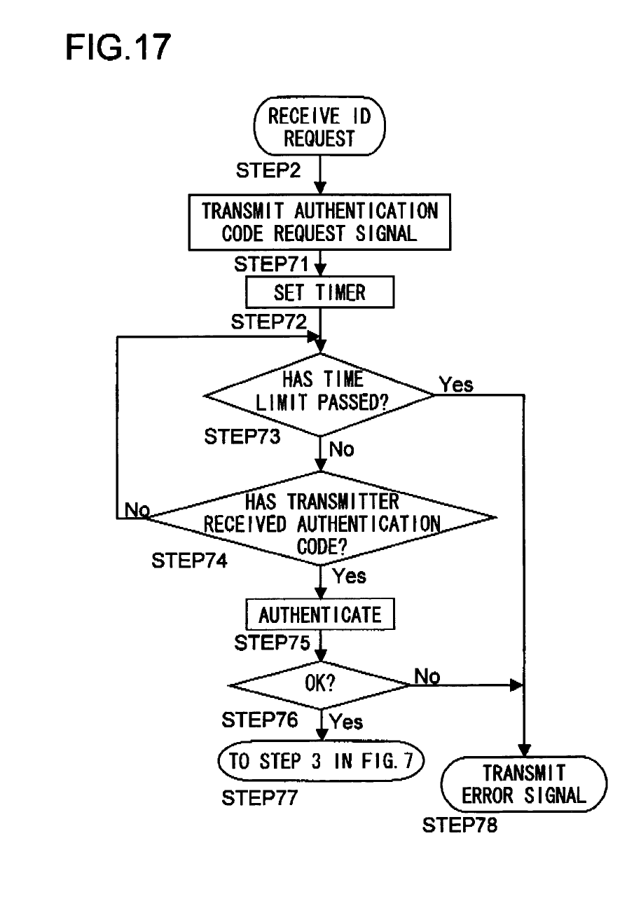

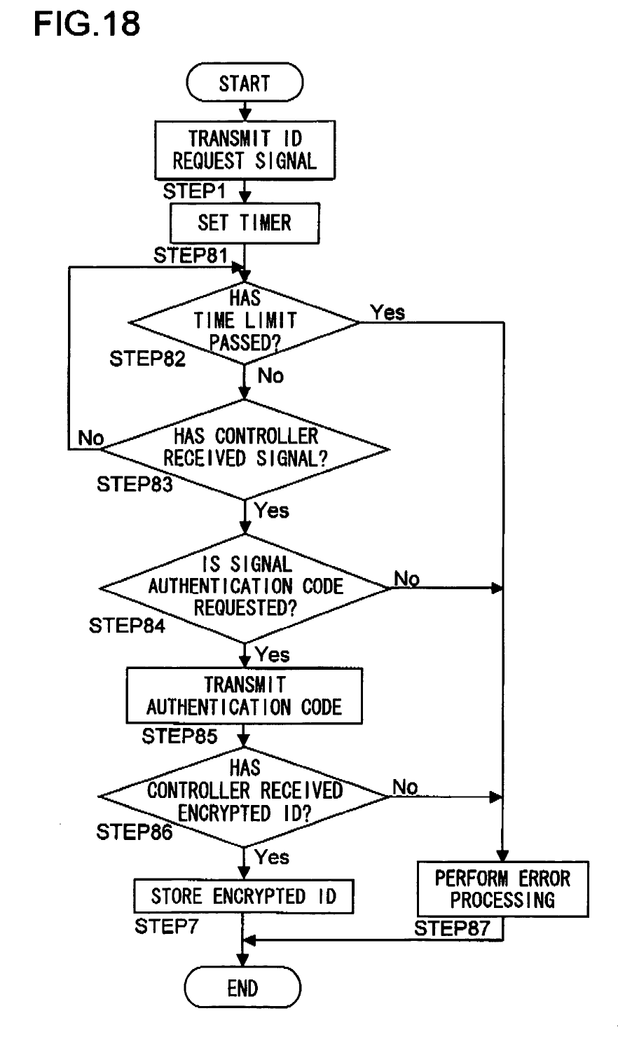

The ID code setting operation of the AV data wireless communication system that includes such a remote controller 5a will next be described. During the ID code setting operation, the AV data transmitter 3 operates according to flowcharts of FIGS. 7 and 17 and the remote controller 5a operates according to the flowchart of FIG. 18, whereby the AV data transmitter 3 generates the encrypted ID code and the decryption code, the encrypted ID code is transmitted to the remote controller 5a, and the decryption code is transmitted to the AV data receiver 4 over wireless communication.

When the remote controller 5a transmits the ID request signal to the AV data transmitter 3 over infrared communication (STEP 1), the timer (not shown) included in the control unit 583 of the remote controller 5a sets the time limit (STEP 81) to determine whether the time limit has passed (STEP 82). When the time limit has not passed (No in STEP 82), it is determined whether the remote controller 5a has received the signal transmitted from the AV data transmitter 3 over infrared communication (STEP 83).

When the remote controller 5a has received the signal from the AV data transmitter 3 (Yes in STEP 83), the control unit 583 determines whether this signal is an authentication code request signal (STEP 84). When the control unit 583 determines that the infrared signal reception unit 581 receives the authentication code request signal (Yes in STEP 84), the control unit 583 reads out the authentication code from the authentication code storage unit 586 and the infrared signal transmission unit 582 transmits the authentication code to the AV data transmitter 3 (STEP 85). When the remote controller 5a has not received the signal (No in STEP 83), the processing proceeds to STEP 82. When the remote controller 5a has received an error signal (No in STEP 84) or the time limit has passed (Yes in STEP 82), the remote controller 5a performs an error processing operation (STEP 87).

When the authentication code is transmitted to the AV data transmitter 3 over infrared communication in STEP 85, it is determined whether the remote controller 5a has received the encrypted ID code from the AV data transmitter 3 (STEP 86). When it is determined that the infrared signal reception unit 581 of the remote controller 5a has received the encrypted ID code from the AV data transmitter 3 (Yes in STEP 86), the remote controller 5a stores the received encrypted ID code in the ID storage unit 583 (STEP 7). When the time limit has passed (Yes in STEP 82) or the remote controller 5a has received the error signal (No in STEP 86), the remote controller 5a performs the error processing operation (STEP 87). As the error processing operation in STEP 87, a notification operation for displaying that communication fails or outputting a voice indicating that the communication fails or the like is performed.

When the AV data transmitter 3 receives the ID request signal (STEP 2) while the remote controller 5a operates as described above, the code generation unit 525 of the AV data transmitter 3 generates the authentication request signal for issuing the authentication code transmission request to the remote controller 5a, and transmits the authentication request signal thus generated to the remote controller 5a through the remote controller data analysis unit 513 and the infrared signal transmission unit 517 (STEP 71). The timer (not shown) in the code generation unit 525 sets the time limit (STEP 72) to determine whether the time limit has passed (STEP 73). When the time limit has not passed (No in STEP 73), it is determined whether the AV data transmitter 3 has received the authentication code transmitted from the remote controller 5a over infrared communication (STEP 74).

When the authentication code is received by the infrared signal reception unit 526 and fed to the code generation unit 525 through the remote controller data conversion unit 527 (Yes in STEP 74), the code generation unit 525 performs an authentication operation using the received authentication code (STEP 75). The code generation unit 525 determines whether the remote controller 5a has been authenticated (STEP 76). When the remote controller 5a has been authenticated (Yes in STEP 76), the processing proceeds to STEP 3 in the flowchart of FIG. 7 and the AV data transmitter 3 performs the processings in STEP 3 and the subsequent steps (STEP 77).

That is, in STEP 77, the AV data transmitter 3 performs the operations in STEP 3 to STEP 5, STEP 8, STEP 30 to STEP 32, and STEP 19 to generate the encrypted ID code and the decryption code, transmit the encrypted ID code over infrared communication, and transmit the decryption code over wireless communication. When the time limit has passed (Yes in STEP 73) or it is determined that the remote controller 5a has not been authenticated (No in STEP 76), the AV data transmitter 3 transmits the error signal (STEP 78).

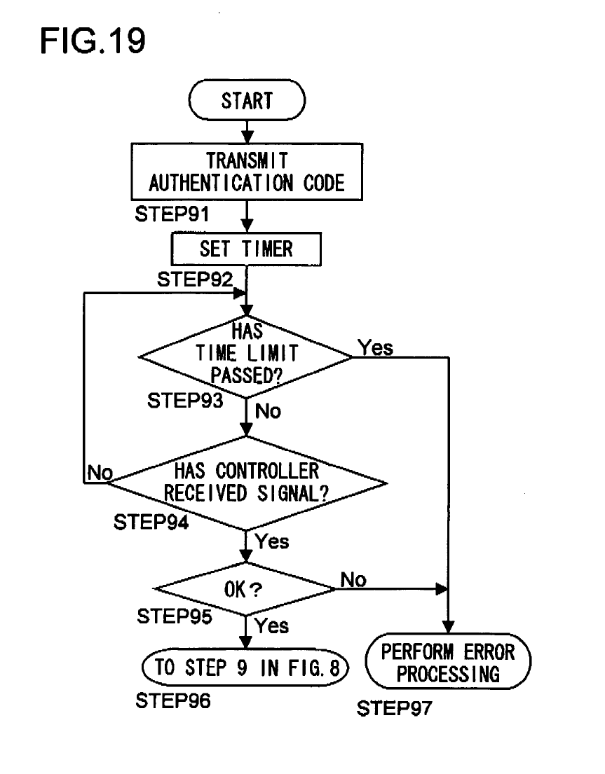

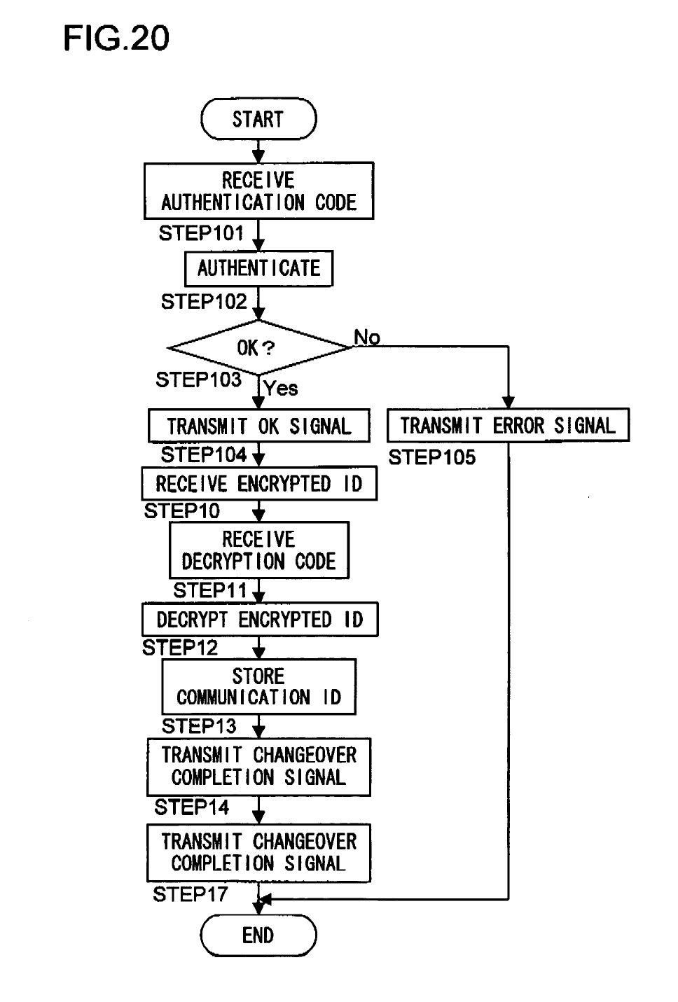

Next, the remote controller 5a operates according to the flowcharts of FIGS. 8 and 19 and the AV data receiver 4 operates according to the flowchart of FIG. 20. As a result, the encrypted ID code is transmitted from the remote controller 5a and received by the AV data receiver 4, and the decryption code transmitted from the AV data transmitter 3 is received by the AV data receiver 4.

When the remote controller 5a is disposed at a position at which the remote controller 5a can communicate with the AV data receiver 4 over infrared communication and the operation unit 585 is actuated, the authentication code is read out from the authentication code storage unit 586 by the control unit 583 and transmitted by the infrared signal transmission unit 582 (STEP 91). The timer (not shown) in the control unit 583 sets a time limit (STEP 92) to determine whether the time limit has passed (STEP 93). When the time limit has not passed (No in STEP 93), the control unit 583 determines whether the remote controller 5a has received an authentication result from the AV data receiver 4 (STEP 94).

When the remote controller 5a has received the authentication result from the AV data receiver 4 (Yes in STEP 94), the control unit 583 determines whether the AV data receiver 4 has authenticated the remote controller 5a based on this authentication result (STEP 95). When the control unit 583 determines that the AV data receiver 4 has authenticated the remote controller 5a (Yes in STEP 95), the processing proceeds to STEP 9 in the flowchart of FIG. 8 and the remote controller 5a performs the operations in STEP 9 and the subsequent steps (STEP 96).

That is, in STEP 96, the remote controller 5a performs the operations in STEP 9, STEP 35 to STEP 37, and STEP 16 to thereby transmit the encrypted ID code and determine that the remote controller 5 has received the changeover completion signal transmitted from the AV data receiver 4 or that the time limit has passed after the transmission of the encrypted ID code. As a result, the encrypted ID code stored in the ID storage unit 584 is deleted. When the time limit has passed (Yes in STEP 93) or the remote controller 5a has received the error signal (No in STEP 95), the remote controller 5a performs the error processing operation (STEP 97). As the error processing operation in STEP 97, similarly to the operations in STEP 87, a notification operation for displaying that communication fails or outputting a voice indicating that the communication fails or the like is performed.

When the infrared signal reception unit 553 of the AV data receiver 4 receives the authentication code from the remote controller 5a (STEP 101) while the remote controller 5a operates as described above, the authentication code is fed to the ID changeover control unit 566 through the remote controller data conversion unit 554 and the ID changeover control unit 566 determines whether to authenticate the remote controller 5a based on the authentication code (STEP 102). Then, it is determined that the remote controller 5a is authenticated (STEP 103). When the remote controller 5a is authenticated (Yes in STEP 103), the ID changeover control unit 566 generates an OK signal indicating that the AV data receiver 4 has authenticated the remote controller 5a, and transmits the OK signal to the remote controller 5a through the remote controller data analysis unit 568 and the infrared signal transmission unit 567 as the infrared signal (STEP 104).

Thereafter, similarly to the timing chart of FIG. 5, the AV data receiver 4 receives the encrypted ID code from the remote controller 5a and receives the decryption code from the AV data transmitter 3 (STEP 10 and STEP 11). In the AV data receiver 4, the ID changeover control unit 566 decrypts the encrypted ID code to thereby obtain the communication ID code (STEP 12). After storing the communication ID data obtained by decrypting the encrypted ID code in the ID storage unit 560, the AV data receiver 4 transmits the changeover completion signal to the remote controller 5a over infrared communication and to the AV data transmitter 3 over wireless communication (STEP 13, STEP 14 and STEP 17). When the AV data receiver 4 has not authenticated the remote controller 5a (No in STEP 103), the AV data receiver 4 transmits an error signal to the remote controller 5a (STEP 105).

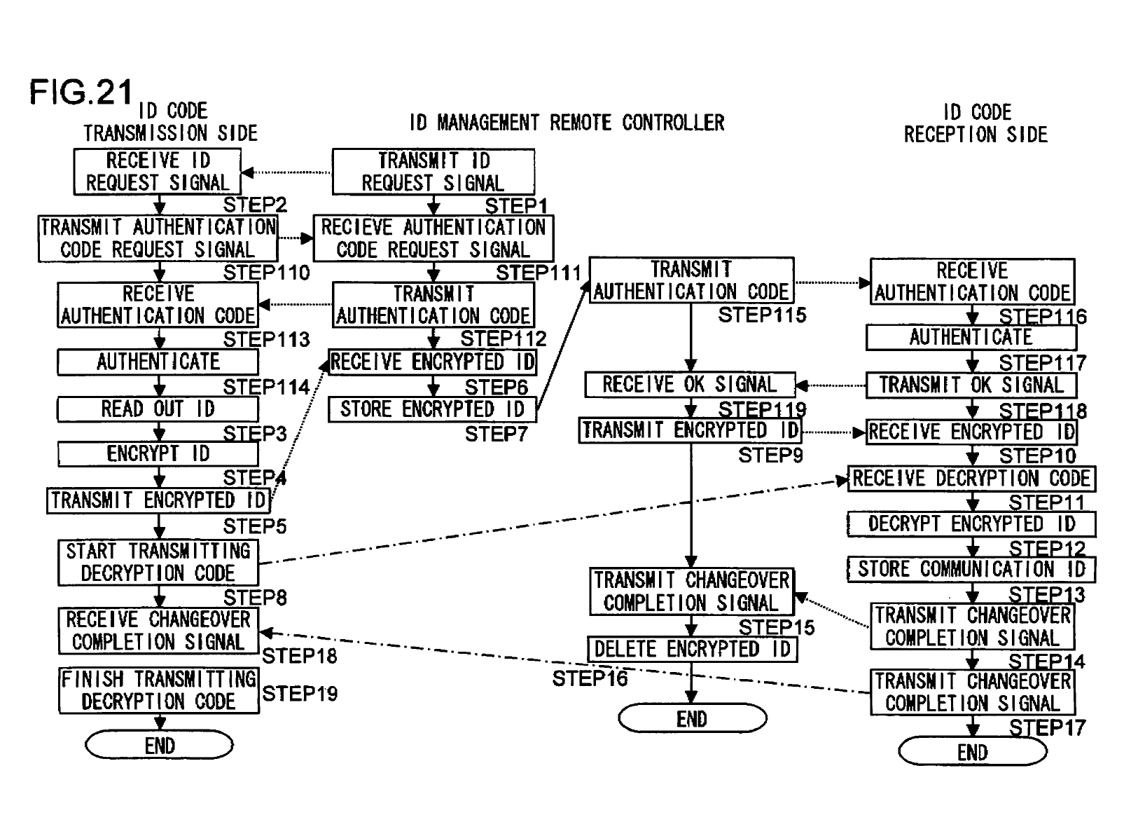

Therefore, when the remote controller 5a transmits the ID request signal as shown in the timing chart of FIG. 21 (STEP 1), the AV data transmitter 3 receives the ID request signal (STEP 2) and transmits the authentication code request signal (STEP 110). After receiving this authentication code request signal (STEP 111), the remote controller 5a transmits the authentication code to the AV data transmitter 3 (STEP 112). When the AV data transmitter 3 receives the authentication code (STEP 113) and authenticates the remote controller 5a (STEP 114), the AV data transmitter 3 confirms the communication ID code, generates the encrypted ID code and the decryption code, and transmits the encrypted ID code and the decryption code (STEP 3 to STEP 5 and STEP 8).

When receiving the encrypted ID code, the remote controller 5a stores the encrypted ID code in the ID storage unit 584 (STEP 6 and STEP 7). When the remote controller 5a transmits the authentication code to the AV data receiver 4 (STEP 115), the AV data receiver 4 receives the authentication code (STEP 116). When the AV data receiver 4 authenticates the remote controller 5a (STEP 117), the AV data receiver 4 transmits the OK signal (STEP 118). Upon receiving this OK signal (STEP 119), the remote controller 5a transmits the encrypted code to the AV data receiver 4 (STEP 9).

Further, after receiving the encrypted ID code from the remote controller 5a and the decryption code from the AV data transmitter 3, the AV data receiver 4 decrypts the encrypted ID code using the decryption code to thereby obtain the communication ID code, stores the communication ID code in the ID storage unit 560, and transmits the changeover completion signal to the remote controller 5a over infrared communication and to the AV data transmitter over wireless communication (STEP 11 to STEP 14 and STEP 17). Accordingly, after receiving the changeover completion signal, the remote controller 5a deletes the encrypted ID code (STEP 15 and STEP 16). In addition, after receiving the changeover completion signal, the AV data transmitter 3 finishes transmitting the decryption code to the AV data receiver 4 (STEP 18 and STEP 19).

In this manner, the AV data transmitter 3 transmits the ID code to the remote controller 5a after determining whether to authenticate the remote controller 5a as a remote controller permitted to hold communication. It is therefore possible to prevent the illegal duplication of the ID code using the remote controller or the like. Further, the AV data transmitter 3 does not transmit the ID code to the AV data receiver which cannot perform authentication based on the authentication code of the remote controller 5a. It is therefore possible to prevent the AV data from being transmitted to the AV data receiver which the AV data transmitter 3 does not permit to communicate with the AV data transmitter 3.

In this embodiment, when the remote controller 5a transmits the ID request signal to the transmitter 3, the remote controller 5a may also transmit the authentication code with the ID request signal. Further, the generation of the encrypted ID code and the decryption of the encrypted ID code are not limited to the operations in the first embodiment, but may be performed by the operations described in, for example, the third embodiment.

In this embodiment, similarly to the first embodiment, the AV data transmitter transmits the ID code to the AV data receiver. Alternatively, similarly to the second embodiment, the AV data receiver may transmit the ID code to the AV data transmitter. In this case, the AV data receiver operates according to the flowcharts of FIGS. 7 and 17 and the AV data transmitter operates according to the flowchart of FIG. 20. In addition, the AV data transmitter and the AV data receiver are constituted as shown in FIGS. 11 and 12, respectively, similarly to the second embodiment.

Fifth Embodiment

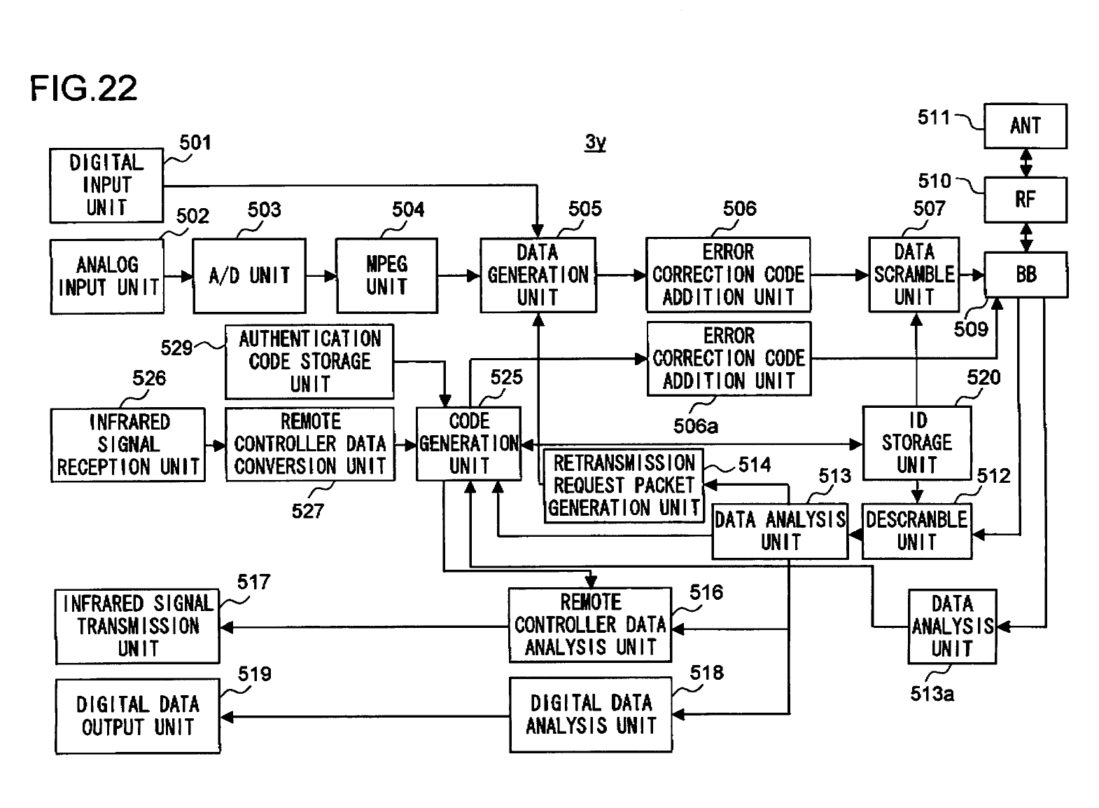

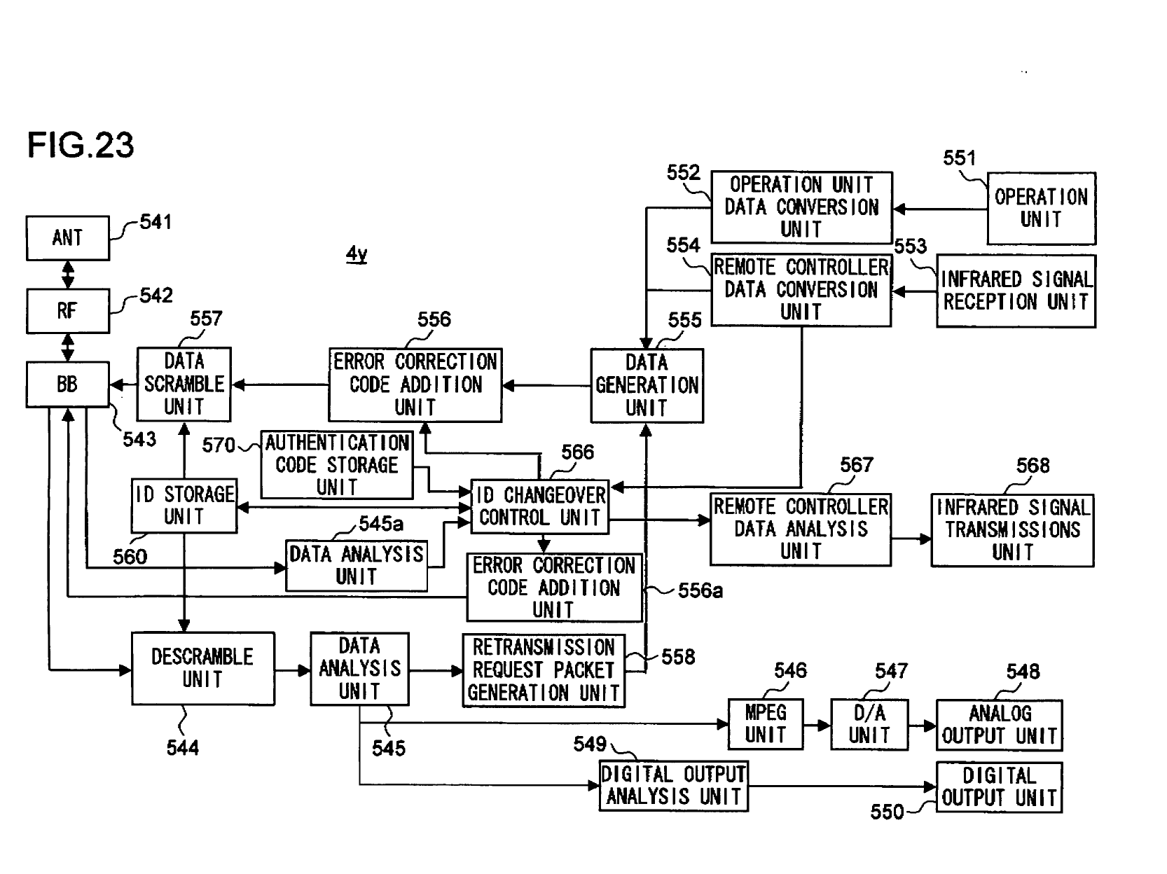

A fifth embodiment of the present invention will be described with reference to the drawings. FIG. 22 is a block diagram which illustrates the internal configuration of an AV data transmitter in the fifth embodiment. FIG. 23 is a block diagram which illustrates the internal configuration of an AV data receiver in the fifth embodiment. In this embodiment, similarly to the fourth embodiment, the AV data wireless communication system constituted as shown in FIG. 1 and the ID management remote controller constituted as shown in FIG. 16 are employed. In addition, in FIGS. 22 and 23, constituent elements of the AV data transmitter and the AV data receiver used for the same purposes as those of the constituent elements shown in FIGS. 2 and 3 are denoted by the same reference symbols as those in FIGS. 2 and 3, respectively, and will not be described herein in detail.

In the fifth embodiment, as shown in FIG. 22, the AV data, transmitter 3y includes an authentication code storage unit 529 that stores the authentication code and a data analysis unit 513a that analyzes the data fed from the BB 509 based on the error correction code and that feeds the analyzed data to the code generation unit 525 as well as the constituent elements shown in FIG. 2, and the code generation unit 525 confirms the authentication code stored in the authentication code storage unit 529. As shown in FIG. 23, the AV data receiver 4y includes an authentication code storage unit 570 that stores the authentication code and an error correction code addition unit 556a that adds the error correction code to the data fed from the ID changeover control unit 566 and that feeds the resultant data to the BB 543 as well as the constituent elements shown in FIG. 3, and the ID changeover control unit 566 confirms the authentication code stored in the authentication code storage unit 570. Further, in the remote controller 5a shown in FIG. 16, the control unit 583 rewrites a content of the authentication code storage unit 586.

With this constitution, the authentication code from the AV data transmitter 3y is transmitted to the remote controller 5a over infrared communication and temporarily stored in the remote controller 5a. When the AV data receiver 4y holds infrared communication with the remote controller 5a, the authentication code from the AV data receiver 4y is transmitted to the remote controller 5a. In the remote controller 5a, the authentication code of the AV data receiver 4y is compared with the authentication code of the AV data transmitter 3y that is temporarily stored in the remote controller 5a to thereby determine whether to authenticate the AV data transmitter 3y and the AV data receiver 4y.

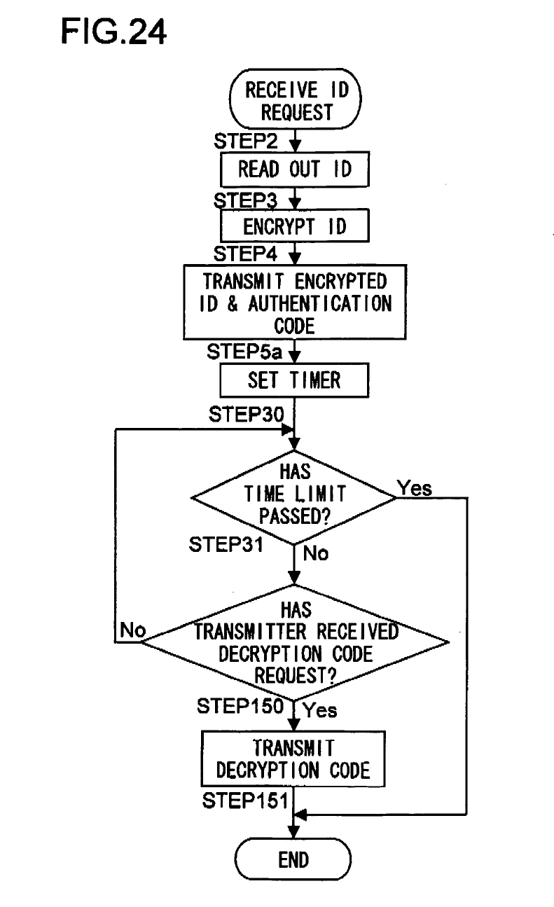

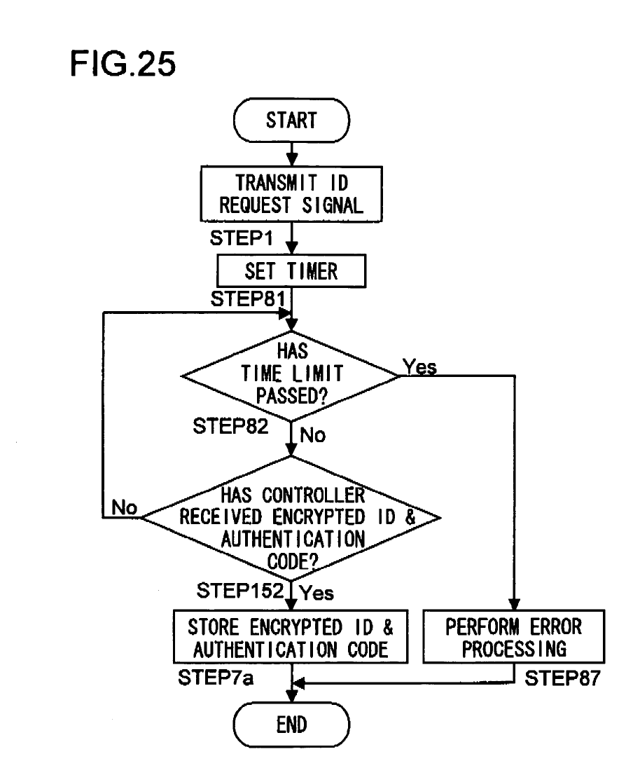

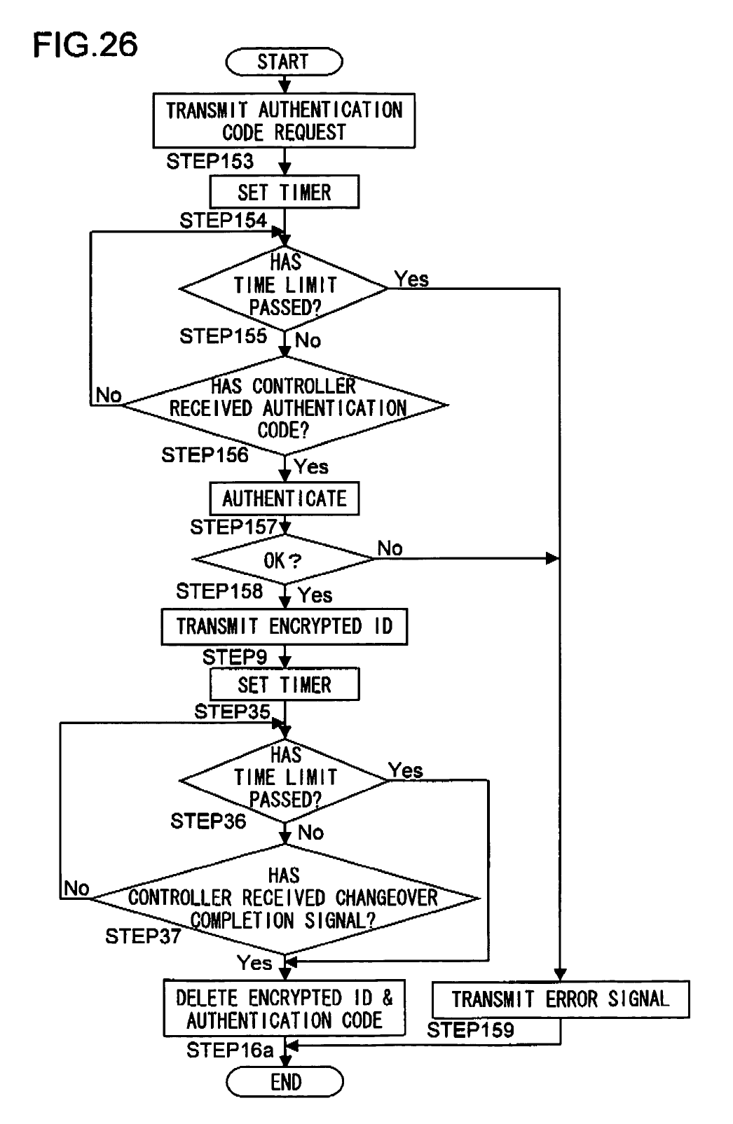

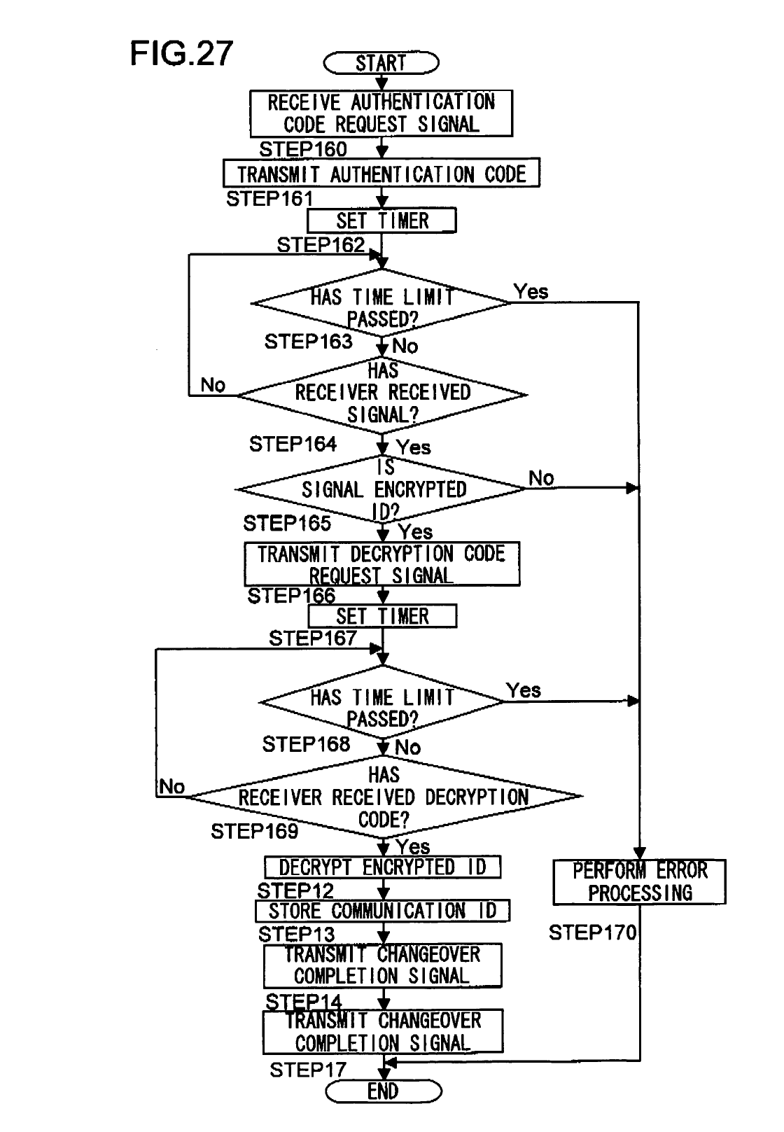

The ID code setting operation of the AV data wireless communication system constituted as described above will be described. During the ID code setting operation, the AV data transmitter 3y operates according to the flowchart of FIG. 24, the remote controller 5a operates according to the flowcharts of FIGS. 25 and 26, and the AV data receiver 4y operates according to the flowchart of FIG. 27.

When the remote controller 5a transmits the ID request signal to the AV data transmitter 3y over infrared communication (STEP 1), the timer (not shown) in the control unit 583 sets the time limit (STEP 81) to determine whether the time limit has passed (STEP 82). When the time limit has not passed (No in STEP 82), it is determined whether the remote controller 5a has received the encrypted ID code and the authentication code transmitted from the AV data transmitter 3y over infrared communication (STEP 152). When it is determined that the remote controller 5a has received the encrypted ID code and the authentication code transmitted from the AV data transmitter 3y (Yes in STEP 152), the control unit 583 stores the encrypted ID code in the ID storage unit 584 and stores the authentication code in the authentication code storage unit 586 (STEP 7a).

When it is determined that the remote controller 5a has not received the encrypted ID code and the authentication code transmitted from the AV data transmitter 3y (No in STEP 152), the processing proceeds to STEP 82. When it is determined that the time limit has passed (Yes in STEP 82), the remote controller 5a performs the error processing operation (STEP 87). As the error processing operation in STEP 87, a notification operation for displaying that communication fails or outputting a voice indicating that the communication fails or the like is performed.

When the AV data transmitter 3y receives the ID request signal from the remote controller 5a while the remote controller 5a operates as described above, the AV data transmitter 3y confirms the communication ID code and generates the encrypted ID code and the decryption code (STEP 2 to STEP 4). The authentication code stored in the authentication storage unit 529 is read out by code generation unit 525 and transmitted together with the encrypted ID code through the remote controller data analysis unit 516 and the infrared signal transmission unit 517 as the infrared signal (STEP 5a).

When the remote controller 5a that stores the authentication code and the encrypted ID code transmitted from the AV data transmitter 3y is disposed at a position at which the controller 5a can hold infrared communication with the AV data receiver 4y and the operation unit 585 of the controller 5a is actuated, the control unit 583 generates the authentication code request signal for requesting the AV data receiver 4y to transmit the authentication code and the infrared signal transmission unit 582 transmits the authentication code request signal (STEP 0.153). The timer (not shown) in the control unit 582 sets the time limit (STEP 154) to determine whether the time limit has passed (STEP 155).

When it is not determined that the time limit has passed (No in STEP 155), it is determined whether the remote controller 5a has received the authentication code from the AV data receiver 4y (STEP 156). When it is determined that the infrared signal reception unit 581 of the remote controller 5a has received the authentication code from the AV data receiver 4y (Yes in STEP 156), the control unit 583 reads out the authentication code of the AV data transmitter 3y stored in the authentication code storage unit 586 and compares the authentication code thus read with the authentication code of the AV data receiver 4y (STEP 157). The remote controller 5a performs the authentication operation by thus comparing the authentication code of the AV data transmitter 3y with that of the AV data receiver 4y. Thereafter, when the remote controller 5a confirms the authentication result (STEP 158) and authenticates the AV data receiver 4y (Yes in STEP 158), the remote controller 5a transmits the encrypted ID code stored in the ID storage unit 584 to the AV data receiver 4y (STEP 9).

Thereafter, the timer (not shown) sets the time limit to determine whether the time limit has passed and to determine whether the remote controller 5a has received the changeover completion signal from the AV data receiver 4y (STEP 35 to STEP 37). When it is determined that the remote controller 5a has received the changeover completion signal or that the time limit has passed, the control unit 583 deletes the encrypted ID code stored in the ID storage unit 584 and the authentication code stored in the authentication code storage unit 586 (STEP 16a). When it is determined that the time limit has passed (Yes in STEP 155) or the remote controller 5a does not authenticate the AV data receiver 4y (No in STEP 158), the remote controller 5a transmits the error signal to the AV data receiver 4y (STEP 159).

At this time, when the infrared signal reception unit 553 of the AV data receiver 4y receives the authentication code request signal and the authentication code request signal is fed to the ID changeover control unit 566 through the remote controller data conversion unit 554 (STEP 160), the authentication code is read out from the authentication code storage unit 570 and transmitted to the remote controller 5a through the remote controller data analysis unit 567 and the infrared signal transmission unit 568 as the infrared signal (STEP 161). The timer (not shown) in the ID changeover control unit 566 sets the time limit (STEP 162) to determine whether the time limit has passed (STEP 163).

When the time limit has not passed (No in STEP 163), the ID changeover control unit 566 determines whether the AV data receiver 4y has received the infrared signal from the remote controller 5a (STEP 164). When the AV data receiver 4y has received the infrared signal from the remote controller 5a (Yes in STEP 164), the ID changeover control unit 566 determines whether the received signal is the encrypted ID code (STEP 165). When it is determined that the received signal is the encrypted ID code (Yes in STEP 165), the ID changeover control unit 566 generates the decryption code request signal for requesting the AV data transmitter 3y to transmit the decryption code, the error correction code addition unit 556a adds the error correction code to the generated decryption code request signal, and the resultant signal is transmitted through the BB 543, the RF 542 and the antenna 541 (STEP 166).

The timer (not shown) in the ID changeover control unit 566 sets the time limit again (STEP 167) to determine whether the time limit has passed (STEP 168). When the time limit has not passed (No in STEP 168), it is determined whether the AV data receiver 4y has received the decryption code from the AV data transmitter 3y (STEP 169). When the AV data receiver 4y receives the decryption code through the antenna 541, the RF 542 and the BB 543 and the received decryption code is fed to the ID changeover control unit 566 through the data analysis unit 545a (Yes in STEP 169), the ID changeover control unit 566 decrypts the encrypted ID code with the decryption code to store the obtained communication ID code in the ID storage unit 560 (STEP 12 and STEP 13).

Thereafter, the AV data receiver 4y transmits the changeover completion signal to the remote controller 5a over infrared communication and to the AV data transmitter 3y over wireless communication (STEP 14 and STEP 17). When the time limit has passed (Yes in STEP 163 or STEP 168) or it is determined that the AV data receiver 4y has received the error signal from the remote controller 5a (No in STEP 164), the AV data receiver 4y performs the error processing (STEP 170). When performing this error processing, the AV data receiver 4y performs the notification operation for displaying a notification indicating abnormality or outputting a voice to notify the abnormality.

Further, after the AV data transmitter 3y transmits the encrypted ID code and the authentication code in STEP 5a, the timer (not shown) in the code generation unit 525 sets the time limit to determine whether the time limit has passed (STEP 30 and STEP 31). When the time limit has not passed (No in STEP 31), the code generation unit 525 determines whether the AV data transmitter 3y has received the decryption code request signal from the AV data receiver 4y (STEP 150).

When the AV data transmitter 3y receives this decryption code request signal through the antenna 511, the RF 510 and the BB 509 and feeds the received decryption code request signal to the code generation unit 525 through the data analysis unit 513a (Yes in STEP 150), the decryption data is transmitted to the AV data receiver 4y through the error correction code addition unit 506a, the BB 509, the RF 510 and the antenna 511 (STEP 151). When the time limit has passed (Yes in STEP 31), the AV data transmitter 3y finishes the operation. When the code generation unit 525 does not determine that the AV data transmitter 3y has received the decryption code request signal (No in STEP 150), the processing proceeds to STEP 31 to determine whether the time limit has passed.

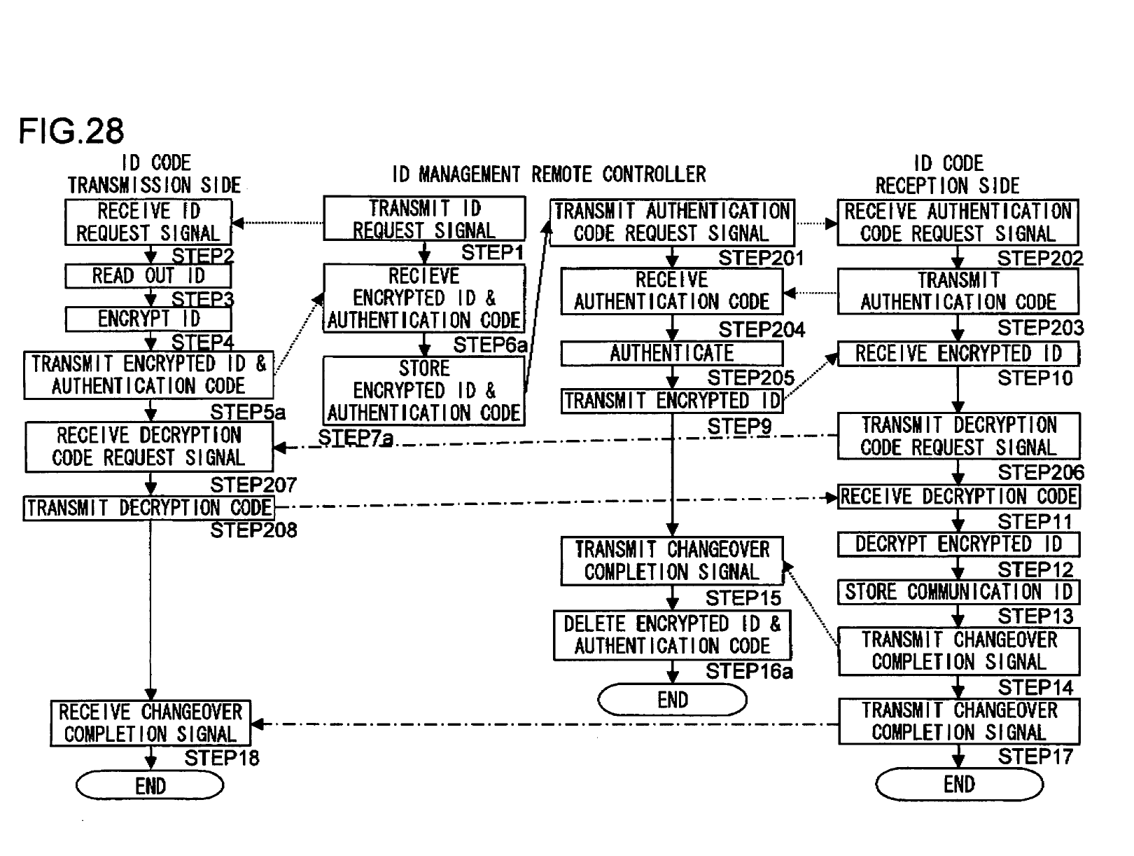

Therefore, as shown in the timing chart of FIG. 28, when the remote controller 5a transmits the ID request signal to the AV data transmitter 3y (STEP 1), the AV data transmitter 3y receives the ID request signal, confirms the communication ID code, and generates the encrypted ID code and the decryption code (STEP 2 to STEP 4). The AV data transmitter 3y transmits the authentication code read out from the authentication code storage unit 529 together with the encrypted ID code to the remote controller 5a (STEP 5a).

When the remote controller 5a receives the authentication code and the encrypted ID code from the AV data transmitter 3y (STEP 6a), the remote controller 5a stores the encrypted ID code in the ID storage unit 584 and the authentication code in the authentication code storage unit 586 (STEP 7a). Thereafter, the remote controller 5a transmits the authentication code request signal to the AV data receiver 4y (STEP 201). When receiving the authentication code request signal (STEP 202), the AV data receiver 4y reads out the authentication code stored in the authentication code storage unit 570 and transmits the authentication code to the remote controller 5a (STEP 203).

When the remote controller 5a receives the authentication code from the AV data receiver 4y (STEP 204), the control unit 583 of the remote controller 5a compares the authentication code of the AV data transmitter 3y stored in the authentication code storage unit 586 with the authentication code of the AV data receiver 4y to authenticate the AV data receiver 4y (STEP 205). When the remote controller 5a authenticates the AV data receiver 4y, reads out the encrypted ID code from the ID storage unit 584 and transmits the encrypted code, the AV data receiver 4y receives the encrypted ID code (STEP 10 and STEP 11).

When it is determined that the AV data receiver 4y has received the encrypted ID code, the AV data receiver 4y generates the decryption code request signal and transmits the decryption code request signal to the AV data transmitter 3y over wireless communication (STEP 206). When the AV data transmitter 3y receives the decryption code request signal (STEP 207), the AV data transmitter 3y transmits the decryption code generated by the code generation unit 525 to the AV data receiver 4y over wireless communication (STEP 208).

When the AV data receiver 4y receives the decryption code from the AV data transmitter 3y, decrypts the encrypted ID code and obtains the communication ID code, the AV data receiver 4y stores the communication ID code in the ID storage unit 560 and transmits the changeover completion signal to the remote controller 5a over infrared communication and to the AV data transmitter 3y over wireless communication (STEP 11 to STEP 14 and STEP 17). Accordingly, after receiving the changeover completion signal, the remote controller 5a deletes the encrypted ID code and the authentication code (STEP 15 and STEP 16a). In addition, the AV data transmitter 3y receives the changeover completion signal and, thereby, determines that the AV data receiver 4y has completed the changeover of the ID code (STEP 18).

With the above operations, the remote controller 5a can determine whether to authenticate the AV data receiver 4y as the receiver that the AV data transmitter 3y permits to communicate with the AV data transmitter 3y and restrict the reception of the AV data from the AV data transmitter 3y to the AV data receiver 4y that the remote controller 5a does not authenticate.

In this embodiment, similarly to the fourth embodiment, after authenticating the remote controller, the AV data transmitter may transmit the encrypted ID code and the authentication to the remote controller. Further, the generation of the encrypted ID code and the decryption of the encrypted ID code are not limited to the operations in the first embodiment but may be performed by the operations described in, for example, the third embodiment.

In this embodiment, similarly to the first embodiment, the AV data transmitter transmits the ID code to the AV data receiver. Alternatively, similarly to the second embodiment, the AV data receiver may transmit the ID code to the AV data transmitter. In this case, the AV data receiver operates according to the flowcharts of FIG. 24 and the AV data transmitter operates according to the flowchart of FIG. 27. In addition, the AV data transmitter and the AV data receiver are constituted as shown in FIGS. 22 and 23, respectively, similarly to this embodiment.

Sixth Embodiment

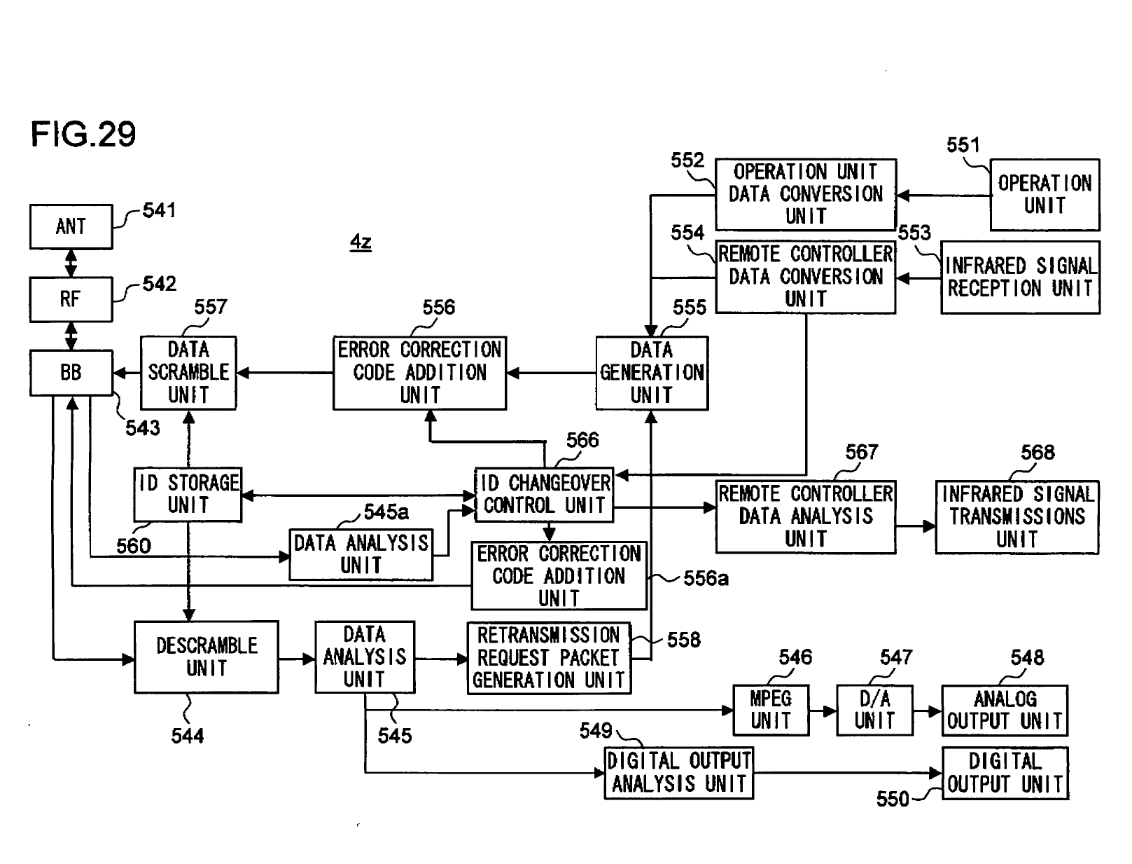

A sixth embodiment of the present invention will be described with reference to the drawings. FIG. 29 is a block diagram which illustrates the internal configuration of an AV data receiver. In this embodiment, similarly to the fifth embodiment, the AV data wireless communication system constituted as shown in FIG. 1, the AV data transmitter constituted as shown in FIG. 22, and the ID management remote controller constituted as shown in FIG. 16 are employed. In FIG. 29, constituent elements of the AV data receiver used for the same purpose as those of the constituent elements shown in FIG. 23 are denoted by the same reference symbols as those shown in FIG. 23, respectively, and will not be described herein in detail.

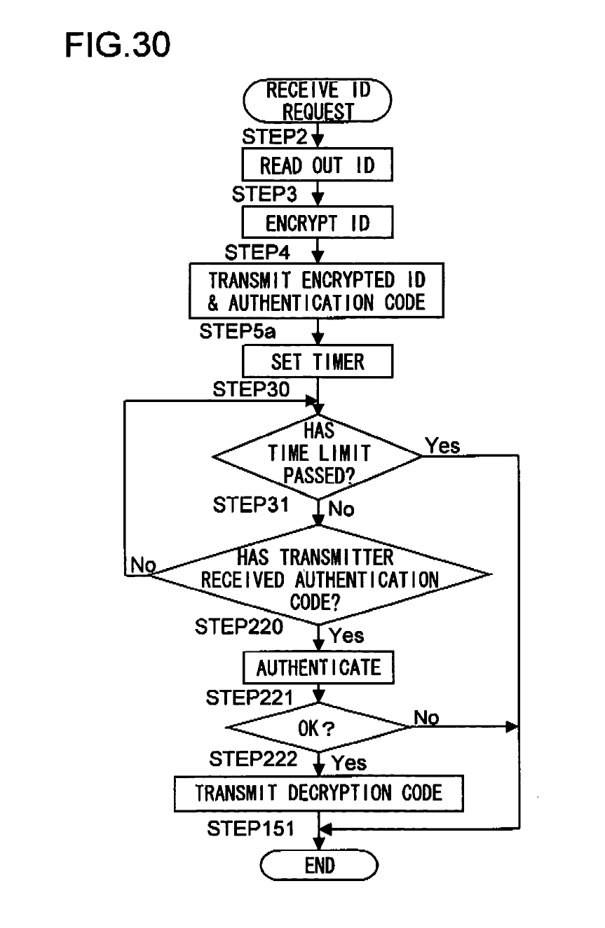

In the sixth embodiment, as shown in FIG. 29, the AV data receiver 4z is equal in configuration to that shown in FIG. 23 except that the authentication code storage unit 529 is not provided. In the AV data wireless communication system that includes the AV data receiver 4z thus constituted, the AV data transmitter 3y operates according to the flowchart of FIG. 30 during the ID code setting operation. The remote controller 5a operates according to the flowchart of FIG. 25 when holding infrared communication with the AV data transmitter 3y.

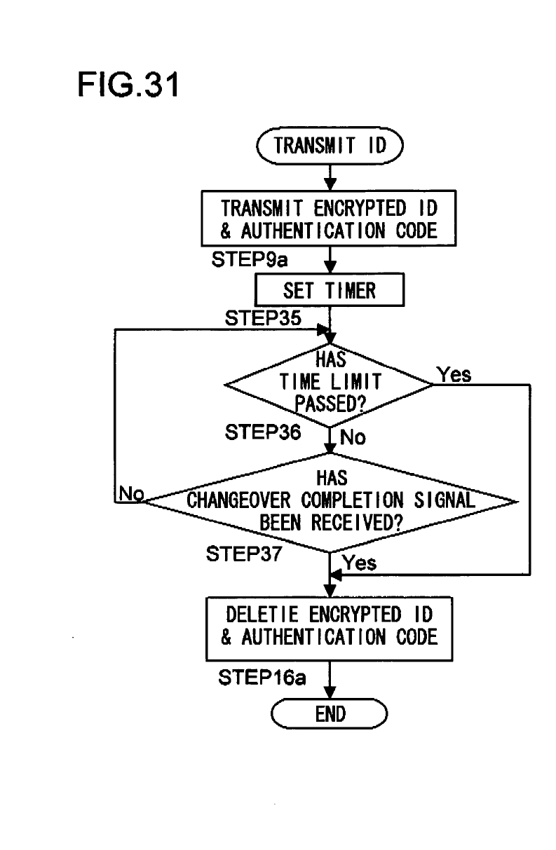

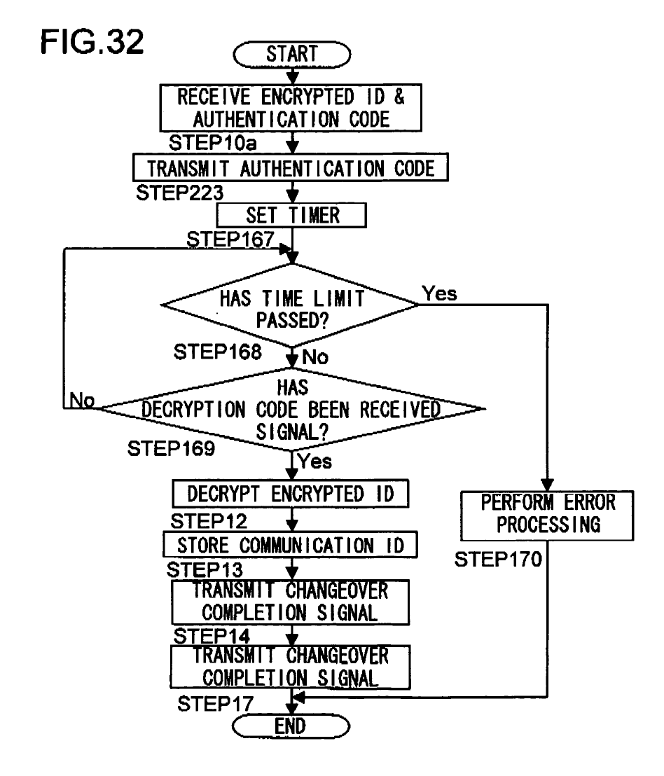

Further, the AV data receiver 4z operates according to the flowchart of FIG. 32. The remote controller 5a operates according to the flowchart of FIG. 31 when holding infrared communication with the AV data receiver 4z. Operations of the AV data transmitter 3y, the AV data receiver 4z and the remote controller 5a that operate according to the respective flowcharts will be described. Since the operations according to the flowchart of FIG. 25 are the same as those in the fourth embodiment, they will not be described herein. In addition, in the flowcharts of FIGS. 30, 31 and 32, the same steps as those in the flowcharts of FIGS. 24, 26 and 27 are denoted by the same reference symbols as those in FIGS. 24, 26 and 27, respectively, and will not be described herein.

When the remote controller 5a transmits the ID request signal and the AV data transmitter 3y receives the ID request signal, the AV data transmitter generates the encrypted ID code and the decryption code, and transmits the encrypted ID code together with the authentication code to the remote controller 5a (STEP 1 to STEP 4 and a STEP 5a). When the remote controller 5a receives the encrypted ID code and the authentication code, the remote controller 5a stores the encrypted ID code and the authentication code and, when not receiving them by the time limit, performs the error processing (STEP 81, STEP 82, STEP 152, STEP 7a and STEP 87).

The AV data transmitter 3y allows the timer (not shown) to set the time limit and determines whether the time limit has passed (STEP 30 and STEP 31). Further, when the remote controller 5a that stores the encrypted ID code and the authentication code is disposed at a position at which the remote controller 5a can hold infrared communication with the AV data receiver 4z and the operation unit 585 of the remote controller 5a is actuated, the control unit 583 reads out the encrypted ID code stored in the ID storage unit 584 and the authentication code stored in the authentication code storage unit 586, and the infrared signal transmission unit 582 transmits the encrypted ID code and the authentication code to the AV data receiver 4z (STEP 9a).

When the remote controller 5a transmits the encrypted ID code and the authentication code to the AV data receiver 4z over infrared communication, the remote controller 5a sets the time limit by the timer and determines whether the controller 5a has received the changeover completion signal transmitted from the AV data receiver 4z over infrared communication by the time limit. When receiving the changeover completion signal or determining that the time limit has passed, the remote controller 5a deletes the encrypted ID code and the authentication code (STEP 35 to STEP 37 and STEP 16a).

In the AV data receiver 4z, when the infrared signal reception unit 553 receives the encrypted ID code and the authentication code and the encrypted ID code and the authentication code are fed from the remote controller data conversion unit 554 to the ID changeover control unit 566 (STEP 10a), the received authentication code is fed to the error correction code addition unit 556a, the error correction code is added to the authentication code, and the resultant authentication code is transmitted to the AV data transmitter 3y through the BB 543, the RF 542 and the antenna 541 (STEP 223).

The AV data receiver 4z sets the time limit by the timer and determines whether the receiver 4z has received the decryption code transmitted from the AV data transmitter 3y by the time limit (STEP 167 to STEP 169). When determining that the AV data receiver 4z has received the decryption code, the AV data receiver 4z decrypts the encrypted ID code with the decryption code to obtain the communication ID code, stores the communication ID code, and transmits the changeover completion signal to the remote controller 5a over infrared communication and to the AV data transmitter 3y over wireless communication (STEP 12 to STEP 14 and STEP 17). When the AV data receiver 4z does not receive the decryption code by the time limit, the AV data receiver 4z performs the error processing (STEP 170).

The AV data transmitter 3y, which determines that the time limit has not passed in STEP 31, determines the reception of the authentication code transmitted from the AV data receiver 4z (STEP 220). When receiving the authentication code through the antenna 511, the RF 510 and the BB 509 and feeding the authentication code to the code generation unit 525 through the data analysis unit 513a (Yes in STEP 220), the AV data transmitter 3y compares this authentication code with the authentication code stored in the authentication code storage unit 529 and authenticates the AV data receiver 4z (STEP 221).

When determining whether to authenticate the AV data receiver 4z (STEP 222) and authenticating the AV data receiver 4z (Yes in STEP 222), the AV data transmitter 3y transmits the decryption code to the AV data receiver 4z over wireless communication (STEP 151). When the AV data transmitter 3y does not determine that the authentication code has received (No in STEP 220), the processing proceeds to STEP 31 to determine whether the time limit has passed. When the AV data transmitter 3y does not authenticate the AV data receiver 4z (No in STEP 222), the AV data transmitter 3y finishes the operation.

As described above, in this embodiment, the authentication code is stored only in the AV data transmitter that is the ID code transmission side and transmitted to the AV data receiver that is the ID code reception side through the remote controller, and transmitted again to the AV data transmitter from the AV data receiver to determine whether to authenticate the AV data receiver. Therefore, it is possible to ensure that the AV data transmitter authenticates the AV data receiver.

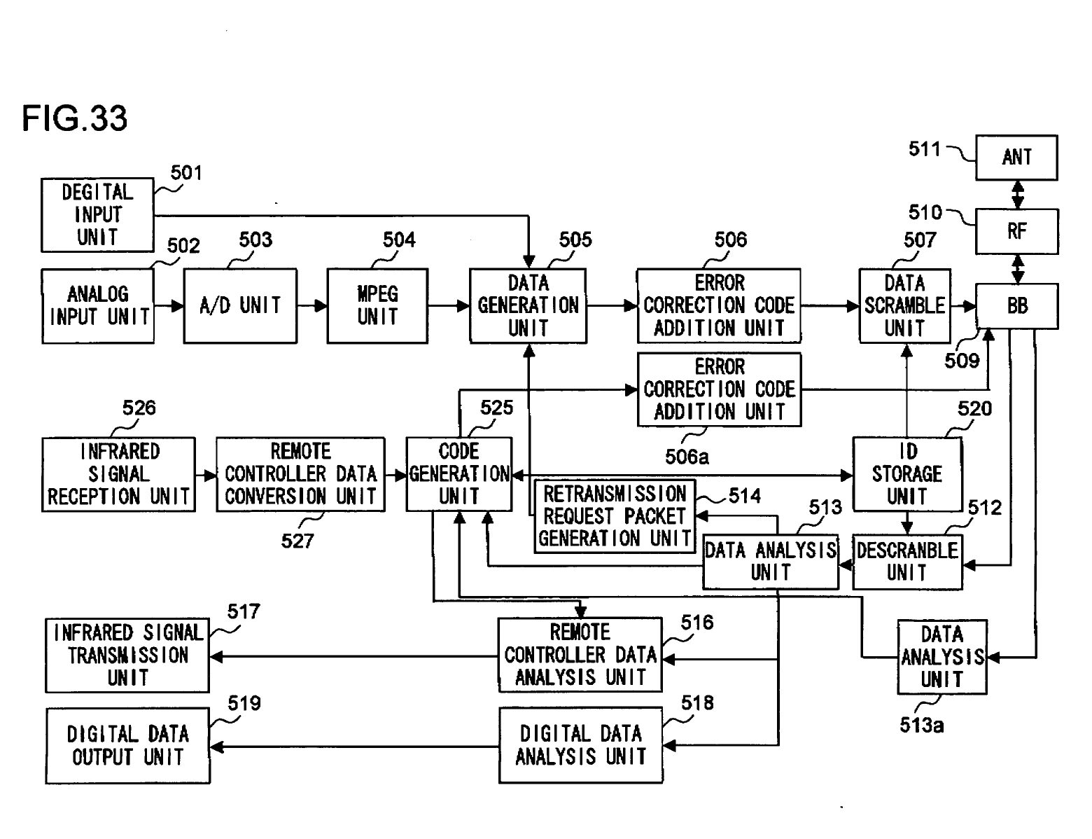

In this embodiment, the ID code transmission side is the AV data transmitter and the ID code reception side is the AV data receiver. Alternatively, similarly to the second embodiment, the ID code transmission side may be the AV data receiver and the ID code reception side may be the AV data transmitter. At this time, the AV data receiver operates according to the flowchart of FIG. 30 and the AV data transmitter operates according to the flowchart of FIG. 32. In addition, the AV data transmitter is constituted as shown in FIG. 33, i.e., equal in configuration to that shown in FIG. 22 except that the authentication code storage unit 529 is not provided, and the AV data receiver is constituted as shown in FIG. 23.

Furthermore, similarly to the fourth embodiment, after authenticating the remote controller, the AV data transmitter may transmit the encrypted ID code and the authentication code. Further, the generation of the encrypted ID code and the decryption of the encrypted ID code are not limited to the operations in the first embodiment, but may be performed by the operations described in, for example, the third embodiment.

In the embodiments described above, the remote controller that holds infrared communication is employed as a medium that transmits the encrypted ID code from the ID code transmission side to the ID code reception side. However, the medium is not limited to the remote controller and the encrypted ID code may be transmitted from the ID code transmission side to the ID code reception side through the other medium. Examples of the medium other than the remote controller 5 or 5a include a memory card and an IC card.

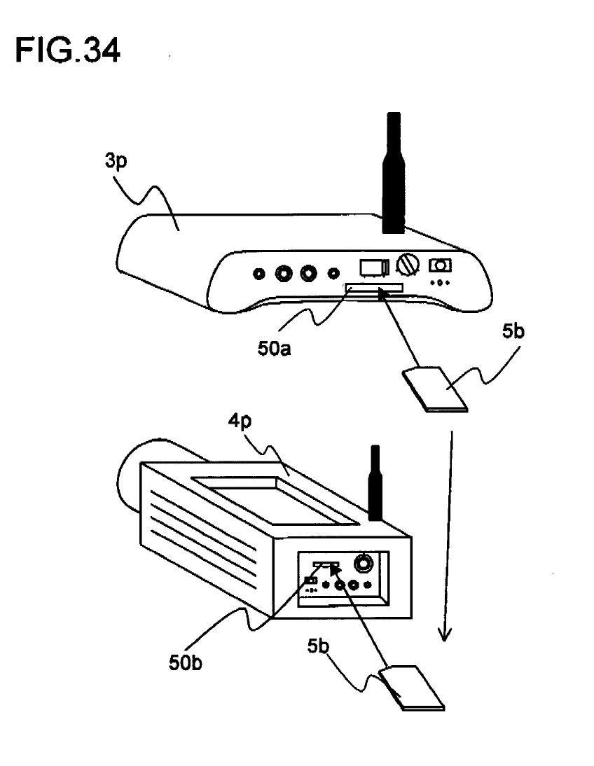

FIG. 34 illustrates an example of employing a memory card as such a medium. The memory card 5b shown in FIG. 34 is inserted into slots 50a and 50b provided in the AV data transmitter 3p and the AV data receiver 4p, respectively. By inserting the memory card 5b into the slots 50a and 50b, the memory card 5b transmits and receives data to and from interfaces (not shown) provided in the AV data transmitter 3p and the AV data receiver 4p and holds communication with the AV data transmitter 3p and the AV data receiver 4p using the above-described encrypted ID code and authentication code.

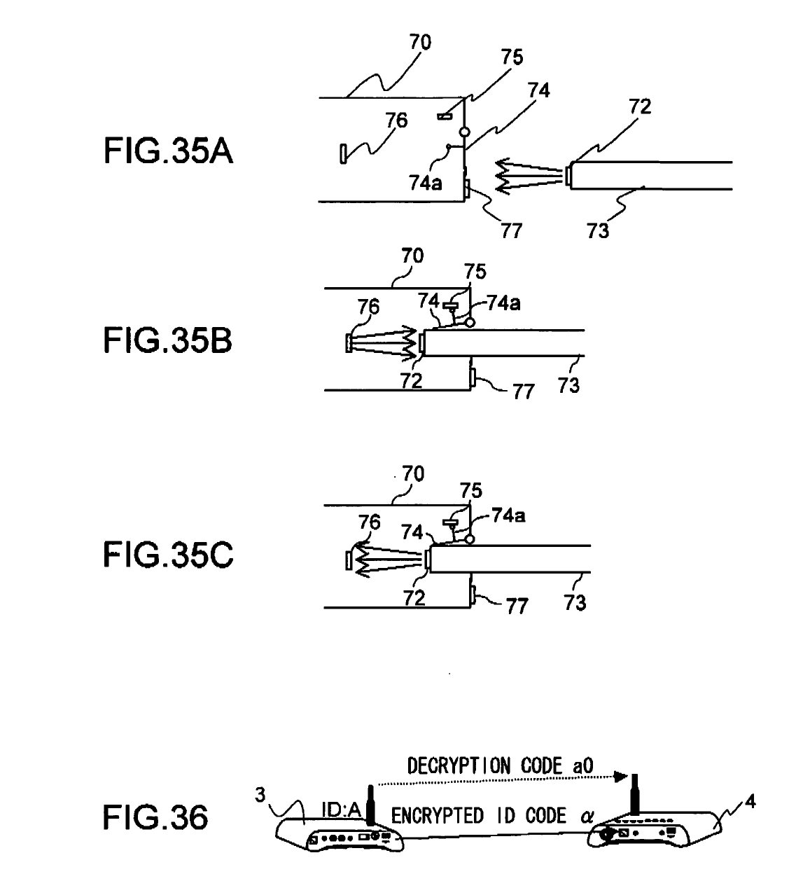

Moreover, as shown in FIGS. 35A to 35C, the remote controller 5 or 5a is constituted as a remote controller 73 having an infrared reception/emission unit 72 provided on a front surface of a box and the AV data transmitter 3 (which may be 3x or 3y) and the AV data receiver 4 (which may be one of 4x to 4z) are constituted as an AV data communication apparatus 70 including an infrared reception/emission unit 76 for holding infrared communication with the remote controller 73 besides an infrared reception/emission unit 77 for holding infrared communication with an ordinary remote controller. In this AV data communication apparatus 70, the infrared reception/emission unit 76 is provided within the AV data communication apparatus 70 and, as shown in FIG. 35A, normally shielded from light by a shield cap 74 provided with a stopper 74a.

When the remote controller 73 is inserted into the AV data communication apparatus 70 from the infrared reception/emission unit 72 so as to push this shield cap 74, as shown in FIG. 35B, the stopper 74a of the shield cap 74 depresses a switch 75. This switch 75 turns on and off the infrared reception/emission unit 76. By allowing the stopper 74a to depress the switch 75, the infrared reception/emission unit 76 is turned on and the infrared signal is transmitted.

Thereafter, when the infrared reception/emission unit 72 of the remote controller 73 receives the infrared signal from the infrared reception/emission unit 76, it is determined that the remote controller 73 is inserted into the communication apparatus 70 from the shield cap 74 and that the remote controller 73 can hold infrared communication with the communication apparatus 70. Accordingly, as shown in FIG. 35C, the infrared reception/emission unit 72 of the remote controller 73 turns into a state in which the infrared reception/emission unit 72 can emit an infrared ray, and the ID request signal, the encrypted ID code, the authentication code and the like are transmitted and received between the communication apparatus 70 and the remote controller 73.

The remote controller 5 or 5a may be constituted as shown in FIGS. 35A to 35C and may be a specific remote controller or may have functions to operate the normal operations of the AV data transmitter and the AV data receiver. The remote controller may also have functions to operate the AV reproduction apparatus and the AV source device.

Seventh Embodiment

A seventh embodiment of the present invention will be described with reference to the drawings. FIG. 36 is a block diagram which illustrates the configuration of an AV data wireless communication system in the seventh embodiment. In this embodiment, similarly to the first embodiment, the AV data transmitter shown in FIG. 2 and the AV data receiver shown in FIG. 3 are employed.

As shown in FIG. 36, the AV data wireless communication system in this embodiment differs from that in the first embodiment in that the ID management remote controller 5 is not provided. Therefore, when the AV data transmitter 3 generates the encrypted ID code α and decryption code a0 based on the communication ID code A, the encrypted ID code α is directly transmitted as the infrared signal from the AV data transmitter 3 to the AV data receiver 4 and the decryption code a0 is transmitted from the AV data transmitter 3 to the AV data receiver 4 over wireless communication. The AV data receiver 4 decrypts the encrypted ID code α using the decryption code a, obtains the communication ID code A, and stores the communication ID code A in the ID storage unit 260.

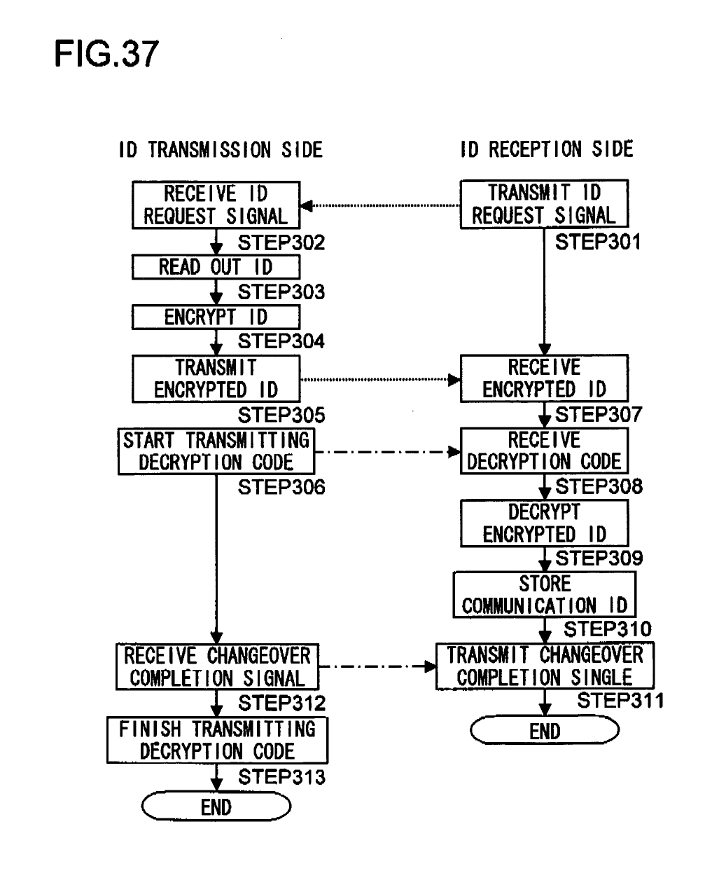

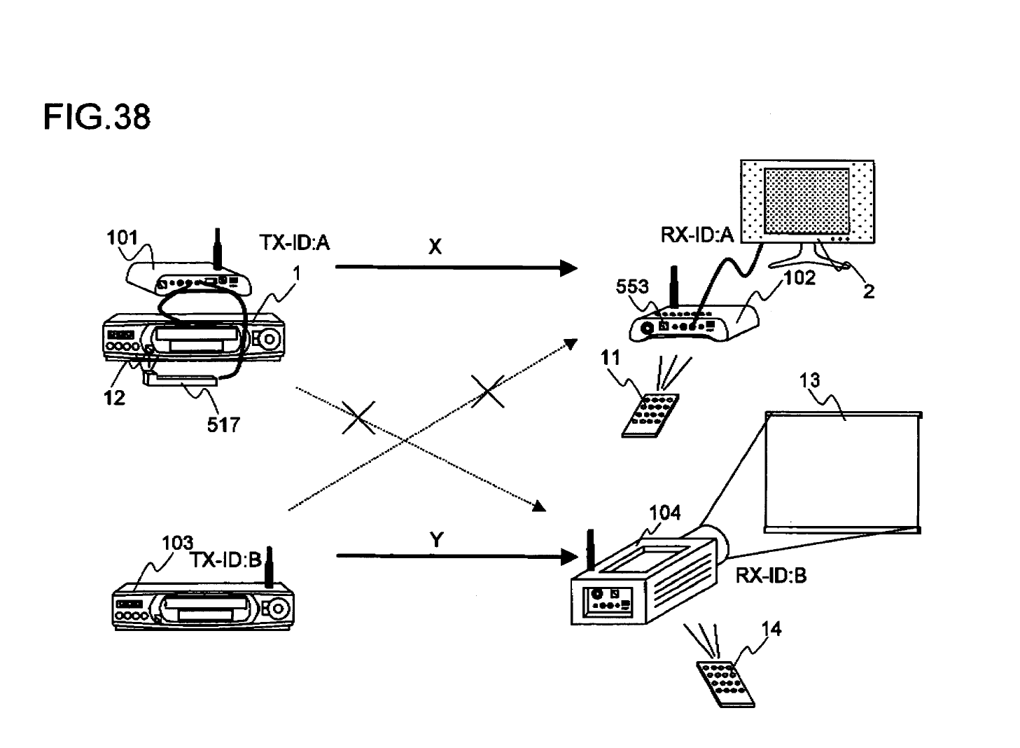

The ID setting operation of the AV wireless communication system constituted as described above is illustrated by the timing chart of FIG. 37. Namely, the AV data receiver 4 transmits the ID request signal to the AV data transmitter 3 over infrared communication (STEP 301). When receiving the ID request signal (STEP 302), the AV data transmitter 3 confirms the communication ID code stored in the ID storage unit 520 (STEP 303) and generates the encrypted ID code and the decryption code (STEP 304). The AV data transmitter 3 transmits the encrypted ID code to the AV data receiver 4 over infrared communication (STEP 305) and transmits the decryption code thereto over wireless communication (STEP 306).

When the AV data receiver 4 receives the infrared signal as the encrypted ID code (STEP 307) and the decryption code transmitted over wireless communication (STEP 308), the AV data receiver 4 decrypts the encrypted ID code with the decryption code and confirms the communication ID code (STEP 309). When storing this communication ID code in the ID storage unit 560 (STEP 310), the AV data receiver 4 transmits the changeover completion signal indicating the completion of the changeover of the communication ID code to the AV data transmitter 3 over wireless communication or infrared communication (STEP 311). Upon receiving this changeover completion signal (STEP 312), the AV data transmitter 3 finishes transmitting the decryption code (STEP 313).

In this embodiment, the AV data wireless communication system, i.e., the AV data transmitter and the AV data receiver perform operations similarly to those in the first embodiment. Alternatively, when the AV data wireless communication system which does not include the remote controller 5 or 5a performs the ID setting operation, the AV data transmitter and the AV data receiver may perform operations similarly to those in the second to sixth embodiment.

In the embodiments described above, the number of times of setting the communication ID code may be restricted in the apparatus which serves as the ID code transmission side or reception side, or the number of ID codes that can be received may be restricted in the apparatus that serves as the ID reception side. An arbitrary key capable of decoding the encrypted ID code to the communication ID code may be used as the decryption code. The system may be constituted so that the reception side stores a plurality of ID codes in advance and that the arbitrary key designates one of the ID codes to decode the communication ID code. Further, the encrypted ID code may be converted within the remote controller or a carrier frequency or the like used by the remote controller for communication may be changed according to the device with which the remote controller communicates.

Furthermore, in the seventh embodiment, the two codes such as the encrypted ID code and the decryption code are used for AV data transmission, transmitted to the apparatus with which the transmission side communicates, and stored in the apparatus. However, the number of codes used for AV data transmission is not limited to two but may be two ore more as long as these plural codes are transmitted to the apparatus with which the transmission side communicates over different mediums. Namely, the communication is not limited to the infrared communication and the wireless communication but may be such that plural codes are transmitted over wireless communication using different frequency bands.

According to the present invention, a communication key signal is delivered based on a setting key signal transmitted using two or more transfer mediums. It is therefore possible to improve the privacy of the communication key signal. In addition, the respective apparatuses or devices are authenticated based on the authentication codes, it is possible to prevent the other apparatus or device that is not permitted to hold communication from intercepting the communication key signal. In addition, by utilizing the portable remote controller and the wireless communication for the transfer medium, even when the communication apparatus is immovable, the communication key signal can be easily delivered. Besides, by transmitting the setting key signal in a specific period, interception and duplication can be prevented.

What is claimed is:

1. An AV data wireless communication system comprising:
an AV data transmitter encrypting an AV data signal including a voice or a picture with a communication key signal, and transmitting the encrypted AV data signal; and
an AV data receiver decrypting the received AV data signal, wherein
in the case where one of the AV data transmitter and the AV data receiver is defined as a first communication apparatus and the other one is defined as a second communication apparatus,
when the first communication apparatus requests the second communication apparatus to transmit the communication key signal,
the second communication apparatus generates two or more setting key signals based on the communication key signal of the second communication apparatus, and transmits all of the setting key signals to the first communication apparatus using different transfer mediums, respectively, the different transfer mediums being as many as the setting key signals, and
the first communication apparatus decodes the original communication key signal using all of the received setting key signals, and establishes communication with the second communication apparatus.

2. The AV data wireless communication system according to claim 1, wherein
one of the transfer mediums is a transfer medium used when the AV data signal is transmitted and received.

3. The AV data wireless communication system according to claim 1, further comprising:
an electronic device that mediates one of the transfer mediums, wherein
after the second communication apparatus transmits one of the setting key signals to the electronic device and the electronic device stores the transmitted setting key signal, the electronic device transmits the setting key signal to the first communication apparatus.

4. An AV data wireless communication system comprising:
an AV data transmitter encrypting an AV data signal including a voice or a picture with a communication key signal, and transmitting the encrypted AV data signal; and
an AV data receiver decrypting the received AV data signal, wherein
in the case where one of the AV data transmitter and the AV data receiver is defined as a first communication apparatus and the other one is defined as a second communication apparatus,
when the first communication apparatus requests the second communication apparatus to transmit the communication key signal,
the second communication apparatus generates a first setting key signal and a second setting key signal based on the communication key signal of the second communication apparatus, transmits the first key signal to the first communication apparatus using a first transfer medium, and transmits the second setting key signal to the first communication apparatus using a second transfer medium, and
the first communication apparatus decodes the original communication key signal using the received first and second setting key signals, stores the communication key signal, and establishes communication with the second communication apparatus.

5. The AV data wireless communication system according to claim 4, wherein
in the second communication apparatus, the first setting key signal and the second setting key signal each vary according to timings at which the first and second setting key signals are generated.

6. The AV data wireless communication system according to claim 5, wherein
time information is synchronized between the first communication apparatus and the second communication apparatus, and
the second communication apparatus generates the first setting key signal and the second setting key signal, which vary every time the first and second setting key signals are generated, using the time information upon generation of the first setting key signal and the second setting key signal.

7. The AV data wireless communication system according to claim 6, wherein
when the first communication apparatus decodes the communication key signal based on the first setting key signal and the second setting key signal, the first communication apparatus decodes the communication key signal using the time information.

8. The AV data wireless communication system according to claim 7, wherein
when the first communication apparatus decodes the communication key signal based on the first setting key signal and the second setting key signal, the first communication apparatus uses the time information while changing the time information by as much as a predetermined time.

9. The AV data wireless communication system according to claim 4, wherein
at least one of the first setting key signal and the second setting key signal is transmitted from the second communication apparatus to the first communication apparatus in a specific period.

10. The AV data wireless communication system according to claim 4, wherein
when the first communication apparatus receives the first setting key signal, the first communication apparatus requests the second communication apparatus to transmit the second setting key signal.

11. The AV data wireless communication system according to claim 10, wherein
the second communication apparatus transmits the second setting key signal for a certain period after the first communication apparatus requests the second communication apparatus to transmit the second setting key signal.

12. The AV data wireless communication system according to claim 4, wherein
when the second communication apparatus receives a changeover completion signal indicating that the communication key signal is generated and stored, from the first communication apparatus, the second communication apparatus finishes transmitting the second setting key signal.

13. The AV data wireless communication system according to claim 4, wherein
at least one of the first communication apparatus and the second communication apparatus has a communication apparatus authentication code for authenticating the other communication apparatus.

14. The AV data wireless communication system according to claim 4, wherein
at least one of the first communication apparatus and the second communication apparatus has a communication apparatus authentication code based on which the at least one of the first communication apparatus and the second communication apparatus is authenticated by the other communication apparatus.

15. The AV data wireless communication system according to claim 4, wherein
the second communication apparatus has a communication apparatus authentication code for authenticating the first communication apparatus, and
when the second communication apparatus has transmitted the communication apparatus authentication code to the first communication apparatus through the first transfer medium,
the first communication apparatus determines that the transmitted code is the communication apparatus authentication code, and transmits the communication apparatus authentication code to the second communication apparatus, and the second communication apparatus receives the communication apparatus authentication code transmitted from the first communication apparatus, and authenticates the first communication apparatus based on the received communication apparatus authentication code and the communication apparatus authentication code stored in the second communication apparatus.

16. The AV data wireless communication system according to claim 4, wherein
one of the first transfer medium and the second transfer medium is a transfer medium used when the AV data is transmitted and received.

17. The AV data wireless communication system according to claim 4, wherein
one of the first transfer medium and the second transfer medium is a transfer medium that mediates an electronic device, and
one of the first setting key signal and the second setting key signal is transmitted from the second communication apparatus to the electronic device, stored in the electronic device, and transmitted from the electronic device to the first communication apparatus.

18. The AV data wireless communication system according to claim 17, wherein
after transmitting the setting key signal that is one of the first setting key signal and the second setting key signal to the first communication apparatus, the electronic device deletes the setting key signal stored in the electronic device.

19. The AV data wireless communication system according to claim 18, wherein
when the electronic device receives a changeover completion signal indicating that the communication key signal is generated and stored, from the first communication apparatus, the electronic device deletes the setting key signal stored in the electronic device.

20. The AV data wireless communication system according to claim 17, wherein
the electronic device has an electronic device authentication code based on which at least one of the first communication apparatus and the second communication apparatus authenticates the electronic device.

21. The AV data wireless communication system according to claim 20, wherein
when the electronic device has transmitted the electronic device authentication code to the second communication apparatus and the second communication apparatus has authenticated the electronic device based on the electronic device authentication code, the second communication apparatus transmits the setting key signal to the electronic device.

22. The AV data wireless communication system according to claim 20, wherein
when the electronic device has transmitted the electronic device authentication code to the first communication apparatus and the first communication apparatus has authenticated the electronic device based on the electronic device authentication code, the first communication apparatus receives the setting key signal from the electronic device.

23. The AV data wireless communication system according to claim 17, wherein
the second communication apparatus has a communication apparatus authentication code for authenticating the first communication apparatus, and
when the communication apparatus authentication code has been transmitted from the second communication apparatus to the electronic device and stored in the electronic device,
the electronic device transmits the communication apparatus authentication code to the first communication apparatus, and the first communication apparatus determines that the transmitted code is the communication apparatus authentication code and transmits the communication apparatus authentication code to the second communication apparatus, and
the second communication apparatus receives the communication apparatus authentication code transmitted from the first communication apparatus and authenticates the first communication apparatus based on the received communication apparatus authentication code and the communication apparatus authentication code stored in the second communication apparatus.

24. The AV data wireless communication system according to claim 17, wherein
the first communication apparatus and the second communication apparatus have a first communication apparatus authentication code and a second communication apparatus authentication code for authentication, respectively, and
when the second communication apparatus authentication code has been transmitted from the second communication apparatus to the electronic device and stored in the electronic device,
the first communication apparatus transmits the first communication apparatus authentication code to the electronic device, and
the electronic device authenticates the first communication apparatus based on the received first communication apparatus authentication data and the stored second communication apparatus authentication code.

25. The AV data wireless communication system according to claim 17, wherein:
the first communication apparatus and the second communication apparatus comprise a connection state notification unit notifying that the first communication apparatus and the second communication apparatus are communicable with the electronic device.

26. The AV data wireless communication system according to claim 25, wherein
when it is determined by the connection state notification unit that the first communication apparatus and the second communication apparatus are communicable with the electronic device, the electronic device is notified that the first communication apparatus and the second communication apparatus are communicable with the electronic device.

27. The AV data wireless communication system according to claim 26, wherein
the electronic device is a remote controller that holds optical communication with the first communication apparatus and the second communication apparatus,
each of the first communication apparatus and the second communication apparatus includes:
a first light reception/emission unit dedicated to the electronic device; and
a second light reception/emission unit for holding optical communication with a remote controller other than the electronic device that operates the first communication apparatus and the second communication apparatus, and
when it is determined by the connection state notification unit that the first communication apparatus and the second communication apparatus are communicable with the electronic device, the first light reception/emission unit performs a light emission operation to thereby notify the electronic device that the first communication apparatus and the second communication apparatus are communicable with the electronic device.

28. The AV data wireless communication system according to claim 27, wherein
each of the first communication apparatus and the second communication apparatus includes a cap that covers the first light reception/emission unit, the first light reception/emission unit being provided within each of the first communication apparatus and the second communication apparatus, and
when the cap is opened to insert the electronic device and the electronic device faces the first light reception/emission unit, it is determined by the connection state notification unit that the communication apparatus is communicable with the electronic device.

29. The AV data wireless communication system according to claim 17, wherein
the electronic device holds wired communication with the first communication apparatus and the second communication apparatus.

30. The AV data wireless communication system according to claim 17, wherein
the electronic device holds wireless communication with the first communication apparatus and the second communication apparatus.

31. The AV data wireless communication system according to claim 30, wherein
the electronic device is a remote controller that transmits an operation signal for operating at least one of the first communication apparatus and the second communication apparatus.

32. A communication apparatus comprising:
a first interface connected to a first transfer medium through which an AV data signal including a voice or a picture is transmitted and received;
a second interface connected to a second transfer medium other than the first transfer medium;
a cipher key storage unit storing a communication key signal for encrypting or decrypting the AV data signal; and
a cipher key changeover control unit generating the communication cipher key by performing a specific arithmetic operation, and storing the communication cipher key in the cipher key storage unit, wherein
when the communication apparatus requests the communication key signal of a communication apparatus other than the communication apparatus so as to communicate and connect with the other communication apparatus,
the communication apparatus receives a first setting key signal and a second setting key signal generated by the other communication apparatus based on the communication key signal at the first interface and the second interface through the first transfer medium and the second transfer medium, respectively, and
the cipher key changeover control unit performs the specific arithmetic operation using the received first and second setting key signals, thereby decoding the communication key signal and storing the decoded communication key signal in the cipher key storage unit.

33. The communication apparatus according to claim 32, wherein
when the communication key signal is decoded based on the first setting key signal and the second setting key signal, time information is utilized while changing the time information by as much as a predetermined time.

34. The communication apparatus according to claim 32, wherein
the communication apparatus receives at least one of the first setting key signal and the second setting key signal in a specific period.

35. The communication apparatus according to claim 32, wherein
when receiving the first setting key signal, the communication apparatus requests the other communication apparatus to transmit the second setting key signal.

36. The communication apparatus according to claim 32, wherein
the communication apparatus has a communication apparatus authentication code for authenticating the other communication apparatus.

37. The communication apparatus according to claim 32, wherein
the communication apparatus has a communication apparatus authentication code based on which the other communication apparatus authenticates the communication apparatus.

38. The communication apparatus according to claim 32, wherein
the second transfer medium is a transfer medium that mediates an electronic device, and
the second setting key signal transmitted from the other communication apparatus to the electronic device and stored in the electronic device is transmitted from the electronic device and received by the communication apparatus through the second interface.

39. The communication apparatus according to claim 38, wherein
the communication apparatus has an electronic device authentication code based on which the electronic device is authenticated.

40. The communication apparatus according to claim 39, wherein
after authenticating the electronic device based on the electronic device authentication code transmitted from the electronic device, the communication apparatus receives the setting key signal from the electronic device.

41. The communication apparatus according to claim 38, further comprising:
a connection state notification unit notifying that the communication apparatus is communicable with the electronic device.

42. The communication apparatus according to claim 41, wherein
when determining by the connection state notification unit that the communication apparatus is communicable with the electronic device, the communication apparatus is notifies the electronic device that the communication apparatus is communicable with the electronic device.

43. The communication apparatus according to claim 42, further comprising:
a first light reception/emission unit for holding optical communication with the electronic device; and
a second light reception/emission unit for holding optical communication with a remote controller other than the electronic device, wherein
when it is determined by the connection state notification unit that the communication apparatus is communicable with the electronic device, the first light reception/emission unit performs a light emission operation to thereby notify the electronic device that the communication apparatus is communicable with the electronic device.

44. The communication apparatus according to claim 43, further comprising:
a cap that covers the first light reception/emission unit, the first light reception/emission unit being provided within the communication apparatus, wherein
when the cap is opened to insert the electronic device and the electronic device faces the first light reception/emission unit, it is determined by the connection state notification unit that the communication apparatus is communicable with the electronic device.

45. A communication apparatus comprising:
a first interface connected to a first transfer medium through which an AV data signal including a voice or a picture is transmitted and received;
a second interface connected to a second transfer medium other than the first transfer medium;
a cipher key storage unit storing a communication key signal for encrypting or decrypting the AV data signal; and
a setting key signal generation unit which reads out the communication key signal stored in the cipher key storage unit, which performs a specific arithmetic processing, and which generates a first setting key signal and a second setting key signal when determining that the communication cipher key signal is requested, wherein
the first setting key signal and the second setting key signal generated by the setting key signal generation unit are outputted to the first transfer medium and the second transfer medium through the first interface and the second interface, respectively.

46. The communication apparatus according to claim 45, wherein
the first setting key signal and the second setting key signal each vary according to timings at which the first setting key signal and the second setting key signal are generated.

47. The communication apparatus according to claim 46, wherein
when the first setting key signal and the second setting key signal are generated, time information on generation of the first setting key signal and the second setting key signal is used to thereby generate the first setting key signal and the second setting key signal vary every time the first setting key signal and the second setting key signal are generated.

48. The communication apparatus according to claim 45, wherein
at least one of the first setting key signal and the second setting key signal is transmitted in a specific period.

49. The communication apparatus according to claim 45, wherein
when transmission of the second setting key signal is requested after a communication apparatus other than the communication apparatus receives the fist setting key signal, the communication apparatus transmits the second setting key signal for a certain period.

50. The communication apparatus according to claim 45, wherein
when receiving a changeover completion signal indicating that the communication key signal is generated and stored, from a communication apparatus other than the communication apparatus, the communication apparatus finishes transmitting the second setting key signal.

51. The communication apparatus according to claim 45, wherein
the communication apparatus has a communication apparatus authentication code for authenticating a communication apparatus other than the communication apparatus.

52. The communication apparatus according to claim 45, wherein
the communication apparatus has a communication apparatus authentication code based on which a communication apparatus other than the communication apparatus authenticates the communication apparatus.

53. The communication apparatus according to claim 45, wherein
the second transfer medium is a transfer medium that mediates an electronic device, and
the communication apparatus medium transmits the second setting key signal to the electronic device.

54. The communication apparatus according to claim 53, wherein
the communication apparatus has an electronic device authentication code based on which the electronic device is authenticated.

55. The communication apparatus according to claim 54, wherein
after authenticating the electronic device based on the electronic device authentication code transmitted from the electronic device, the communication apparatus transmits the setting key signal to the electronic device.

56. The communication apparatus according to claim 53, further comprising:
a connection state notification unit notifying that the communication apparatus is communicable with the electronic device.

57. The communication apparatus according to claim 56, wherein
when determining by the connection state notification unit that the communication apparatus is communicable with the electronic device, the communication apparatus notifies the electronic device that the communication apparatus is communicable with the electronic device.

58. The communication apparatus according to claim 57, further comprising:
a first light reception/emission unit for holding optical communication with the electronic device; and
a second light reception/emission unit for holding optical communication with a remote controller other than the electronic device, wherein
when it is determined by the connection state notification unit that the communication apparatus is communicable with the electronic device, the first light reception/emission unit performs a light emission operation to thereby notify the electronic device that the communication apparatus is communicable with the electronic device.

59. The communication apparatus according to claim 58, further comprising:
a cap that covers the first light reception/emission unit, the first light reception/emission unit being provided within the communication apparatus, wherein
when the cap is opened to insert the electronic device and the electronic device faces the first light reception/emission unit, it is determined by the connection state notification unit that the communication apparatus is communicable with the electronic device.

60. An electronic device comprising:
an interface connected to a second transfer medium other than a first transfer medium, so as to communicate with a communication terminal that transmits and receives an AV data signal using the first transfer medium; and
a setting key signal storage unit that stores a second setting key signal generated based on a communication key signal so as to encrypt or decrypt the AV data signal, wherein
the electronic device is employed in the AV data wireless communication system according to claim 17, and
after receiving the second setting key signal transmitted from the second communication apparatus through the interface and storing the second setting key signal in the setting key signal storage unit, the electronic device transmits the second setting key signal stored in the setting key signal storage unit to the first communication apparatus through the interface.

61. The electronic device according to claim 60, wherein
after transmitting the second setting key signal to the first communication apparatus, the electronic device deletes the second setting key signal stored in the setting key signal storage unit.

62. The electronic device according to claim 61, wherein
when receiving a changeover completion signal indicating that the communication key signal is generated and stored, from the first communication apparatus, the electronic device deletes the second setting key signal stored in the setting key signal storage unit.

63. The electronic device according to claim 60, wherein
the electronic device has an electronic device authentication code based on which at least one of the first communication apparatus and the second communication apparatus authenticates the electronic device.

64. The electronic device according to claim 60, wherein
the electronic device holds wired communication with the first communication apparatus and the second communication apparatus.

65. The electronic device according to claim 60, wherein
the electronic device holds wireless communication with the first communication apparatus and the second communication apparatus.

66. The electronic device according to claim 65, wherein
the electronic device is a remote controller that transmits an operation signal for operating at least one of the first communication apparatus and the second communication apparatus.
